(19) United States
(12) Patent Application Publication
(10) Pub. No.: US 2019/0329449 A1
(43) Pub. Date: Oct. 31, 2019

(54) CORE DRILL BIT AND METHODS OF FORMING THE SAME

(71) Applicants: SAINT-GOBAIN ABRASIVES, INC., Worcester, MA (US); SAINT-GOBAIN ABRASIFS, Conflans-Sainte-Honorine (FR)

(72) Inventors: Ji WANG, Shanghai (CN); Aiyun LUO, Shanghai (CN); Jian XU, Shanghai (CN); Ji XIAO, Shanghai (CN); Jian ZHANG, Shanghai (CN)

(21) Appl. No.: 16/395,204

(22) Filed: Apr. 25, 2019

(30) Foreign Application Priority Data
Apr. 25, 2018 (CN) 201810382015.7

(51) Int. Cl. B28D 1/04; B28D 5/02

(52) U.S. Cl. CPC B28D 1/041; B28D 5/021

(57) ABSTRACT

A core drill bit can include a first region and a second region. The first region can include abrasive particles in a first bond matrix, and the second region can include abrasive particles in a second bond matrix. The first region is connected to the second region. The first region comprises at least one different abrasive characteristic than the second region. At least one of the first and second region can include a Fast Fourier Transform value greater than 1.

### CROSS-REFERENCE TO RELATED APPLICATION(S)

This application claims priority to Chinese Patent Application No. 201810382015.7 entitled “CORE DRILL BIT AND METHODS OF FORMING THE SAME,” by Ji WANG et al., filed Apr. 25, 2018, which is assigned to the current assignee hereof and incorporated herein by reference in its entirety.

### FIELD OF THE DISCLOSURE

The present invention relates, in general, to core drill bits and methods of forming the same.

### DESCRIPTION OF THE RELATED ART

Core drill bits can be used to generate holes in materials. In applications of drilling brittle materials, such as glass, chipped areas are often formed around edges of drilled holes, due to lack of better control over formation of edges during drilling and nature of glass. Glass core drill bits are worn out quickly and often have reduced service life. The industry continues to demand improved core drill bits, particularly for applications of drilling brittle materials.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a side view of a drill bit in accordance with an embodiment.

FIG. 2 includes an illustration of a side view of a region of a drill bit in accordance with an embodiment.

FIG. 3 includes an illustration of a side view of a region of a drill bit in accordance with another embodiment.

FIG. 4 includes an illustration of a cross-sectional view of a region of a drill bit in accordance with an embodiment.

FIG. 5 includes an illustration of a cross-sectional view of a different region of a drill bit in accordance with an embodiment.

FIG. 6 includes an illustration of an enlarged side view of a portion of a drill bit in accordance with an embodiment.

FIG. 7 includes a flowchart illustrating a process in accordance with an embodiment.

FIG. 8 includes an illustration of a side view of a drill bit in accordance with an embodiment.

FIG. 9 includes an illustration of a scanning electronic microscopic image of a portion of a core drill.

FIGS. 10A to 10E include images of a cross section of a portion of a core drill bit in accordance with an embodiment.

FIGS. 11A to 11D include images of a cross section of a portion of a core drill bit formed by hot pressing.

### DETAILED DESCRIPTION

The following is generally directed to core drill bits that are particularly suitable for cutting brittle materials, such as glass.

Embodiments are directed to a core drill bit having improved performance. The core drill bit can have a first region and a second region, both of which can include abrasive particles contained within a bond matrix. The first and second regions can be bonded abrasive materials including a continuous three-dimensional matrix of bond material and abrasive particles and other materials contained within the bond matrix. Each of the first and second regions can include at least one abrasive characteristic selected from the group including a bond matrix composition, a bond matrix concentration, a bond material composition, a bond material concentration, an infiltrant material composition, an infiltrant concentration, a type of abrasive particles, an average abrasive particle size, an abrasive particle concentration, a type of pores, an average pore size, a pore size distribution, a porosity (vol %), a filler composition, a filler concentration, or any combination thereof. At least one of the first and second regions can have a Fast Fourier Transform value greater than 1. The first region and the second region can define a surface of the core drill bit that is in contact with a substrate in an operation of drilling. The first region and the second region can have at least one different abrasive characteristic, properties, or any combination thereof.

Further embodiments are drawn to a process for forming the core drill bit of embodiments in this disclosure. The process can include forming a precursor body by utilizing an additive manufacturing process. The process can further include applying heat to at least a portion of the precursor body to form a core drill bit including the first region and second region. The first and second regions may facilitate reduced wear of the drill bit and improved edge quality of the workpiece. The core drill bit can be particular suitable for operations of drilling glass, such as automobile glass and flat glass, allowing better control over formation of edges and having improved service life.

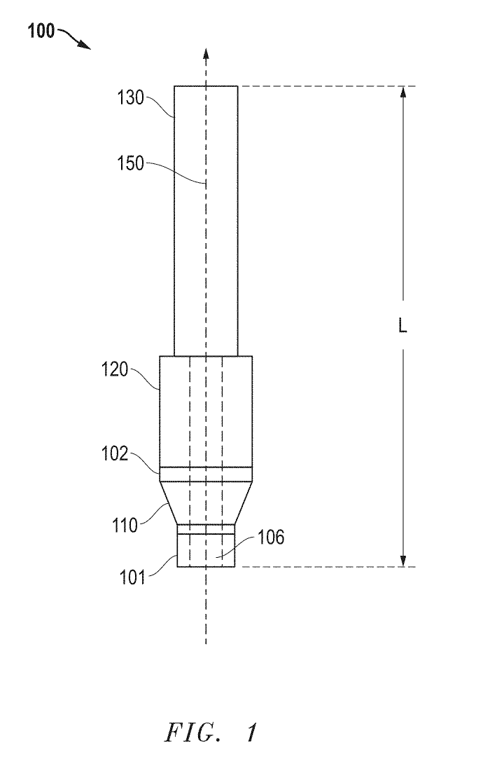

FIG. 1 includes a side view of a core drill bit 100. The core drill bit can include a shaft 130. The shaft 130 can be connected to a drill body 120. The core drill bit can further include an abrasive tip 110, which can be connected to the drill body 120. The abrasive tip 110 can include a first region 101 and a second region 102.

In an embodiment, the first region 101 can include abrasive grains within a first bond matrix. The first bond matrix can include a particular first composition that can facilitate improved formation, properties, and/or operation of the core drill bit. In an embodiment, the first bond matrix can include a first bond material including an elemental metal, a metal alloy, or a combination thereof. An exemplary metal element can include a transition metal element, such as an element selected from Groups 4 to 12 of the periodic table published by IUPAC on Nov. 28, 2016, a metal other than a transition metal, such as a post-transition metal, another metal element, or any combination thereof. A further exemplary metal element can include iron, tungsten, cobalt, nickel, chromium, titanium, silver, tin, zinc, copper, manganese, aluminum, zirconium, niobium, tantalum, vanadium, molybdenum, palladium, gold, cadmium, indium, or a combination thereof. In a particular embodiment, the first bond material can include an alloy including any of the elements noted in embodiments herein. For instance, an exemplary alloy can include iron, such as an iron-based alloy. In instances, the alloy may include a non-metal element, such as carbon, silicon, sulfur, a phosphorus, or combination thereof. In particular instances, the iron-based alloy can include carbon, chromium, manganese, silicon, vanadium, molybdenum, tungsten, or any combination thereof.

In a further embodiment, the first bond matrix can further include a first infiltrant material. In an aspect, the infiltrant material can include a different elemental metal or metal alloy than the first bond material. An exemplary first infiltrant material can include a transition metal, such as silver, iron, copper, tin, aluminum, tin, zinc, cobalt, manganese, nickel, phosphorus, chromium, gold, silicon, indium, titanium, boron, vanadium, or a combination thereof. In still another instance, a silver-based alloy, such as AgCu, AgCuMn, AgCuZn, AgCuTi, AgCuln, or AgTi, may be used as the first infiltrant material. In still another instance, a copper-based alloy, such as bronze or brass, may be used as the first infiltrant material. In still another instance, an iron-based alloy, such as FeCuCr, FeCuCrSn, may be used as the first infiltrant material. In still another instance, an aluminum-based alloy, such as AlCuSi, AlCuSiSn, may be used as the first infiltrant material. In a particular aspect, the first infiltrant material can have lower melting point compared to the first bond material. For instance, the first infiltrant material can have a melting point that may not be greater than 80% of the melting point of the first bond material, such as not greater than 75% or not greater than 70% or not greater than 65% or not greater than 50% of the melting point of the first bond material. In a further aspect, the infiltrant material can bond the first bond material and the abrasive grains together. The first bond material and the first infiltrant material can form the first bond matrix.

In a further embodiment, the first bond matrix can include at least one metal element selected from a transition metal element, a metal other than a transition metal, such as a post-transition metal, or any combination thereof. Particularly, the first bond matrix can include an alloy material including at least one transition metal element, such as Fe. In another instance, the first bond matrix can include Fe and an additional transition metal element. The additional transition metal element can include Co, Cr, Ni, Cu, Zn, Sn, Ti, Zr, Mn, or any combination thereof. In an instance, the first bond matrix can include Fe and Cu. In another example, the first bond matrix can include a material including Fe, Co, and Cu. In still another instance, the first bond matrix can include Fe and an alloy, such as bronze or brass. In more particular instances, the first bond matrix can include a Co-containing material. The Co-containing material can include Co, Fe, Cu, or any combination thereof. Particularly, the Co-containing material can include an alloy including Co, Fe, and Cu. In some other instances, the first bond matrix can include a Co-containing material and an alloy, such as bronze or brass. In another particular embodiment, the first bond matrix may include an impurity, such as, Ca, Cl, Na, or a combination thereof, and the total concentration of all the impurities may not be greater than 1%, such as not greater than 0.5% for the total weight of the first bond matrix. According to one aspect, the first bond matrix can consist essentially of Co, Fe, and Cu. As used herein, the term, consisting essentially of, is intended to mean not greater than 1% of impurities can be included other than the explicitly included components, which in the first bond matrix, are Co, Fe, and Cu.

In an embodiment, the first bond matrix can include a particular concentration of Co that can facilitate improved formation, properties, and/or operation of the core drill bit. For instance, the concentration of Co can be at least 5% for the total weight of the first bond matrix, such as at least 8%, at least 10%, at least 15%, at least 20%, at least 23%, at least 25%, at least 26%, or at least 27%. In another instance, the concentration of Co can be at most 40%, such as at most 38%, at most 32%, at most 31%, at most 29%, at most 28%, at most 27%, at most 25%, or most 20% for the total weight of the first bond matrix. It is to be understood that the concentration of Co in the first bond matrix can be within a range including any of the minimum and maximum percentages disclosed herein. For instance, the first bond matrix can include a concentration of Co within a range including at least 5% and not greater than 40%, such as within a range including at least 15% and not greater than 29%. In another embodiment, the first bond matrix may not include Co.

In an embodiment, the first bond matrix can include a particular concentration of Fe that can facilitate improved formation, properties, and/or operation of the core drill bit. For instance, the concentration of Fe can be at least 10% for the total weight of the first bond matrix, such as at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%. In another instance, the concentration of Fe can be at most 90%, at most 85%, at most 80%, at most 75%, at most 60%, at most 55%, at most 50%, at most 45%, at most 40%, at most 35%, or at most 30% for the total weight of the first bond matrix. It is to be understood that the concentration of Fe in the first bond matrix can be within a range including any of the minimum and maximum percentages disclosed herein. For instance, the first bond matrix can include a concentration of Fe within a range including at least 10% and not greater than 90%, such as within a range including at least 20% and not greater than 80%. In an embodiment, the first bond matrix can include a particular concentration of Cu that can facilitate improved formation, properties, and/or operation of the core drill bit. For instance, the concentration of Cu can be at least 10% for the total weight of the first bond matrix, such as at least 12%, at least 15%, at least 20%, at least 25%, at least 30%, at least 35%, at least 40%, at least 45%, or at least 50%. In another instance, the concentration of Cu can be at most 80%, at most 70%, at most 60%, at most 50%, at most 40%, at most 35%, at most 30%, or at most 25% for the total weight of the bond matrix. It is to be understood that the concentration of Cu in the first bond matrix can be within a range including any of the minimum and maximum percentages disclosed herein. For instance, the first bond matrix can include a concentration of Cu within a range including at least 10% and not greater than 80%, such as within a range including at least 20% and not greater than 70%.

In an embodiment, the first region can include a particular first concentration of the first bond matrix that can facilitate improved formation and properties of the core drill bit. For instance, the first bond matrix concentration can be at least 85% for a total weight of the first region, such as at least 88%, at least 90%, at least 95%, or at least 99%. In another embodiment, the first region can include a first bond matrix concentration of not greater than 99% for a total weight of the first region, such as not greater than 95% or not greater than 90%. It is to be understood that the first bond matrix concentration can be within a range including any of the minimum and maximum percentages noted herein. For instance, the first bond matrix concentration can be within a range including at least 85% and not greater than 99%.

In an embodiment, the first region can include a particular first content of the first bond material that can facilitate improved formation and properties of the core drill bit. For instance, the first region can include at least 5 vol % of the first bond material for the total volume of the first region, such as at least 6 vol %, at least 7 vol %, at least 8 vol %, at least 9 vol %, at least 10 vol %, at least 11 vol %, at least 12 vol %, at least 13 vol %, at least 14 vol %, at least 15 vol %, at least 16 vol %, at least 17 vol %, at least 18 vol %, at least 19 vol %, at least 20 vol %, at least 21 vol %, at least 22 vol %, at least 23 vol %, at least 24 vol % of the first bond material for the total volume of the first region. In another instance, the first region may include not greater than 45 vol % of the first bond material for the total volume of the first region, such as not greater than 42 vol %, not greater than 40 vol %, not greater than 39 vol %, not greater than 38 vol %, not greater than 37 vol %, not greater than 36 vol %, not greater than 35 vol %, not greater than 34 vol %, not greater than 33 vol %, not greater than 32 vol %, not greater than 31 vol %, not greater than 30 vol %, not greater than 29 vol %, not greater than 28 vol %, not greater than 27 vol %, not greater than 26 vol %, not greater than 25 vol %, not greater than 24 vol %, not greater than 23 vol %, not greater than 22 vol %, not greater than 21 vol %, not greater than 20 vol %, not greater than 19 vol %, not greater than 18 vol %, not greater than 17 vol %, not greater than 16 vol %, or not greater than 15 vol % of the first bond material for the total volume of the first region. Moreover, the content of the first bond material can be in a range including any of the minimum and maximum values noted herein, such as in a range from 5 vol % to 45 vol % for the volume of the first region.

In an embodiment, the first region can include a particular first content of the first infiltrant material that can facilitate improved formation and properties of the core drill bit. For instance, the first region can include at least 15 vol % of the first infiltrant material for the total volume of the first region, such as at least 16 vol %, at least 18 vol %, at least 20 vol %, at least 22 vol %, at least 25 vol %, at least 26 vol %, at least 28 vol %, at least 30 vol %, at least 31 vol %, at least 33 vol %, at least 35 vol %, at least 37 vol %, at least 39 vol %, at least 40 vol %, at least 41 vol %, at least 42 vol %, at least 43 vol %, at least 44 vol %, at least 45 vol %, at least 46 vol % at least 47 vol %, at least 48 vol %, at least 49 vol %, at least 50 vol %, at least 51 vol %, at least 52 vol %, at least 53 vol %, at least 54 vol %, or at least 55 vol % of the first infiltrant material for the total volume of the first region. In another instance, the first region may include not greater than 75 vol % of the first infiltrant material for the total volume of the first region, such as not greater than 72 vol %, not greater than 70 vol %, not greater than 69 vol %, not greater than 68 vol %, not greater than 67 vol %, not greater than 66 vol %, not greater than 65 vol %, not greater than 64 vol %, not greater than 63 vol %, not greater than 62 vol %, not greater than 61 vol %, not greater than 60 vol %, not greater than 59 vol %, not greater than 58 vol %, not greater than 57 vol %, not greater than 56 vol %, not greater than 55 vol %, not greater than 54 vol %, not greater than 53 vol %, not greater than 52 vol %, not greater than 51 vol %, not greater than 50 vol %, not greater than 49 vol %, not greater than 48 vol %, not greater than 47 vol %, not greater than 46 vol %, or not greater than 45 vol % of the first infiltrant material for the total volume of the first region. Moreover, the first content of the first infiltrant material can be in a range including any of the minimum and maximum values noted herein, such as in a range from 15 vol % to 75 vol % for the volume of the first region.

In an embodiment, the first region can include a first type of abrasive particles. In an aspect, the first type of abrasive particles can include a superabrasive material. An exemplary superabrasive material can include diamond, cubic boron nitride (cBN), or any combination thereof. In a particular embodiment, the superabrasive material can consist of diamond, cubic boron nitride (cBN), or any combination thereof. In another aspect, the first type of abrasive particles can include a material including oxides, carbides, nitrides, or any combination thereof. For instance, the first type of abrasive particles can include alumina, silicon carbide, boron nitride, or any combination thereof. In another aspect, the first type of abrasive particles can include shaped abrasive particles.

In an embodiment, the abrasive particles can have a first average particle size (D₅₀) of at least 25 microns, such as at least 30 microns, at least 35 microns, at least 40 microns, at least 45 microns, at least 50 microns, at least 55 microns, at least 60 microns, at least 70 microns, at least 80 microns, at least 85 microns, at least 95 microns, at least 100 microns, at least 125 microns, or at least 140 microns. In another embodiment, the abrasive particles can have an average particle size of at most 400 microns, such as at most 370 microns, at most 350 microns, at most 300 microns, at most 280 microns, at most 240 microns, at most 200 microns, at most 130 microns, at most 150 microns, at most 145 microns, at most 120 microns, at most 110 microns, at most 105 microns, at most 100 microns, at most 95 microns, at most 90 microns, at most 85 microns, at most 80 microns, at most 75 microns, at most 70 microns, at most 65 microns, at most 60 microns, at most 50 microns, at most 45 microns, at most 40 microns. It is to be appreciated that the abrasive particles in the first region can have a first average particle size within a range including any of the minimum and maximum values disclosed herein. For instance, the first average particle size of the abrasive particles within the first region can be within a range including at least 25 microns and at most 400 microns or within a range including at least 30 microns and at most 150 microns.

In an embodiment, the first region can include a particular first abrasive particle concentration that can facilitate improved formation and properties of the core drill bit. For example, the first region can include a first abrasive particle concentration of at least 1% for a total weight of the first region, such as at least 3%, at least 4%, at least 5%, at least 6%, at least 8%, or at least 10%. In a further embodiment, the first region may include a first abrasive particle concentration of not greater than about 10% for a total weight of the first region, such as not greater than about 8%, not greater than about 5% or not greater than about 3%. It is to be understood that the first region can include a first abrasive particle concentration within a range including any of the minimum and maximum percentages noted herein. For instance, the first region can include a first abrasive particle concentration within a range including at least 1% and not greater than 10% for a total weight of the first region.

In an embodiment, the first region can include a first filler composition including at least one filler material. An exemplary filler material can include an oxide, a carbide, a nitride, or any combination thereof. In a particular embodiment, the first region may include a first filler composition including silicon carbide, tungsten carbide, tungsten, boron carbide, titanium carbide, zirconium carbide, chromium carbide, alumina, zirconia, fused alumina-zirconia, or any combination thereof.

In a further embodiment, the first region can include a particular first concentration of the first filler composition that can facilitate improved formation and/or performance of the core drill bit. For instance, the first region can include the first filler composition at a first concentration of at least 1% for the total weight of the first region, such as at a concentration of at least 2%, at least 3%, at least 4%, at least 5%, at least 6%, or at least 7%, at least 8%, at least 9%, at least 10%, at least 12%, at least 13%, at least 14%, at least 15%, at least 16%, or at least 17%, at least 18%, at least 19%, at least 20%, at least 22%, at least 24%, at least 26%, at least 27%, at least 29%, or at least 30%, at least 32%, at least 33%, at least 34%, at least 35%, at least 36%, or at least 37%, at least 38%, at least 39%, at least 40%, at least 42%, at least 43%, at least 44%, at least 45%, at least 46%, or at least 47%, at least 48%, at least 49%, or at least 50%. In another instance, the first filler concentration may be not greater than 50%, such as not greater than 48%, not greater than 46%, not greater than 45%, not greater than 44%, not greater than 43%, not greater than 42%, not greater than 41%, not greater than 40%, not greater than 39%, or not greater than 38% not greater than 37%, not greater than 35%, not greater than 32%, not greater than 31%, not greater than 30%, not greater than 29%, not greater than 28%, not greater than 27%, not greater than 26%, or not greater than 25%. Moreover, the first concentration of the first filler composition can be in a range including any of the minimum and maximum percentages noted herein, such as in a range from 1% to 50% for the total weight of the first region.

The first region may have a particular porosity that may facilitate improved formation, properties, and/or operation of the core drill bit. In an embodiment, the first region may have a first porosity of not greater than 45 vol % for a total volume of the first region, such as not greater than 40 vol %, not greater than 35 vol %, not greater than 30 vol %, not greater than 25 vol %, or not greater than 20 vol %, not greater than 15 vol %, not greater than 10 vol %, not greater than 5 vol %, not greater than 4 vol %, or not greater than 3 vol %. In another embodiment, the first region can have a first porosity of at least 0.2 vol % for a total volume of the first region, such as at least 0.5 vol %, at least 0.8 vol %, at least 1 vol %, at least 1.5 vol %, at least 2 vol %, at least 4 vol %, at least 5 vol %, at least 8 vol %, at least 10 vol %, at least 12 vol %, at least 15 vol %, or at least 20 vol % for a total volume of the first region. It is to be understood that the first region can include a first porosity within a range including any of the minimum and maximum percentages disclosed herein. For instance, the first region can have a first porosity within a range including at least 0.2 vol % to not greater than 45 vol %, or in a range including at least 0.2 vol % and not greater than 5 vol % for a total volume of the first region. In a particular instance, the first region may be essentially free of pores.

In an embodiment, the first region can include first type of pores including closed pores, interconnected pores, or a combination thereof.

In an embodiment, the first region can include a first pore size distribution including D₁₀, D₉₀, D₅₀, or any combination thereof. D₁₀ may define the maximum pore size of the pores in the lowest 10% of the distribution (i.e., the pore size of the pores in the 10^{th} percentile of the distribution). D₉₀ may define the minimum pore size of the pores in the greatest 10% of the distribution (i.e., the pore size of the pores in the 90^{th} percentile of the distribution). As used herein, D₅₀ is also referred to as an average pore size.

In an aspect, the first region may include a particular first average pore size (D₅₀) that may facilitate improved formation, properties, and/or operation of the core drill bit. In an aspect, the first average pore size may be at least 0.01 microns, at least 0.05 microns, at least 0.1 microns, at least 0.2 microns, such as at least 0.5 microns, at least 0.8 microns, at least 1 micron, at least 1.3 microns, at least 1.5 microns, at least 2 microns, at least 2.5 microns, at least 3 microns, at least 4 microns, at least 5 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, at least 100 microns, or at least 110 microns. In another aspect, the average pore size may be at most 350 microns, such as at most 330 microns, at most 310 microns, at most 300 microns, at most 290 microns, at most 270 microns, at most 250 microns, at most 230 microns, at most 210 microns, at most 180 microns, at most 150 microns, at most 130 microns, at most, 110 microns, at most 100 microns, at most 90 microns, at most 70 microns, at most 50 microns, at most 30 microns, at most 10 microns, at most 8 microns, at most 5 microns, at most 3 microns, or at most 1 micron. In a further aspect, the first region can include a first average pore size in a range including any of the minimum and maximum values noted herein.

In an aspect, the first pore size distribution can include a particular first D₁₀ that may facilitate improved formation, properties, and/or operation of the core drill bit. For instance, the first D₁₀ can be at least 0.001 microns, at least 0.005 microns, at least 0.01 microns, at least 0.02 microns, at least at least 0.05 microns, at least 0.1 microns, at least 0.2 microns, such as at least 0.5 microns, at least 0.8 microns, at least 1 micron, at least 1.3 microns, at least 1.5 microns, at least 2 microns, at least 2.5 microns, at least 3 microns, at least 4 microns, at least 5 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, or at least 80 microns. In another instance, the first D₁₀ may be at most 290 microns, at most 270 microns, at most 250 microns, at most 230 microns, at most 210 microns, at most 180 microns, at most 150 microns, at most 130 microns, at most, 110 microns, at most 100 microns, at most 90 microns, at most 70 microns, at most 50 microns, at most 30 microns, at most 10 microns, at most 8 microns, at most 5 microns, at most 3 microns, or at most 1 micron. Moreover, the first D₁₀ can be in a range including any of the minimum and maximum values noted herein.

In another aspect, the first pore size distribution can include a particular first D₉₀ that may facilitate improved formation, properties, and/or operation of the core drill bit. For instance, the first D₉₀ can be at least 0.05 microns, at least 0.1 microns, at least 0.2 microns, such as at least 0.5 microns, at least 0.8 microns, at least 1 micron, at least 1.3 microns, at least 1.5 microns, at least 2 microns, at least 2.5 microns, at least 3 microns, at least 4 microns, at least 5 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, at least 100 microns, at least 110 microns, at least 130 microns, or at least 150 microns. In another instance, the first D₉₀ may be at most 450 microns, at most 400 microns, at most 350 microns, such as at most 330 microns, at most 310 microns, at most 300 microns, at most 290 microns, at most 270 microns, at most 250 microns, at most 230 microns, at most 210 microns, at most 180 microns, at most 150 microns, at most 130 microns, at most, 110 microns, at most 100 microns, at most 90 microns, at most 70 microns, at most 50 microns, at most 30 microns, at most 10 microns, at most 8 microns, or at most 5 microns. Moreover, the first D₉₀ can be in a range including any of the minimum and maximum values noted herein.

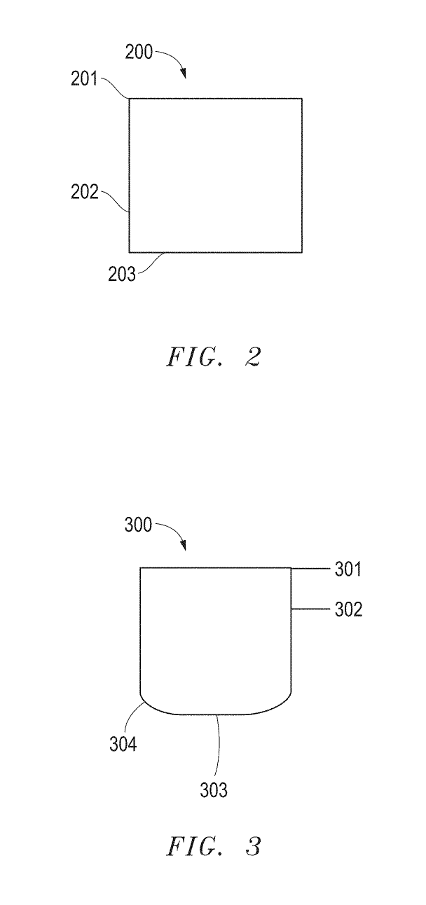

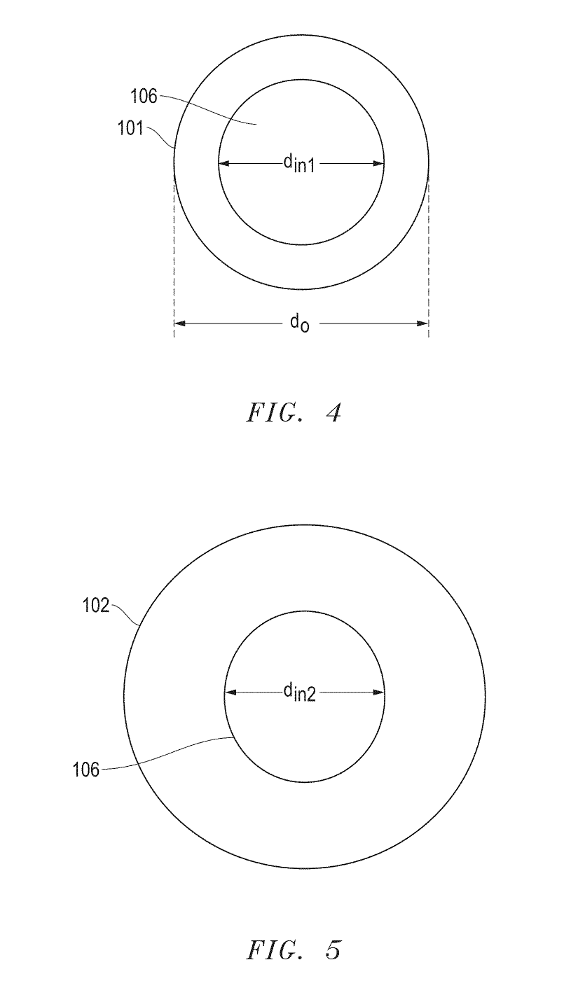

FIG. 2 includes an illustration of a side view of an exemplary embodiment of the first region. The first region 200 can include an upper end 201 that can be connected to the second region (e.g., 102). The peripheral wall 202 can be perpendicular to the upper end 201 and the bottom end 203 that is opposite the upper end. FIG. 3 includes a side view illustration of another embodiment of the first region. The first region 300 can include the upper end 301 that is similar to the upper end 201. The peripheral wall 302 can be perpendicular to the upper end 301 and connected to the bottom end 303 by a beveled edge 304. The bottom ends 202 and 303 can be in direct contact with a workpiece in drilling operations. From the side view, the beveled edge can be linear or curvier. In some particular applications, the beveled edge can be a curve from the side view. Having a beveled edge at the tip of a core drill bit can help to reduce load of the drilling machine and improve core drill adaptation.

In another embodiment, the second region can include abrasive grains within a second bond matrix. The first bond matrix and the second bond matrix can have a different composition, concentration, property, or any combination thereof. In a particular embodiment, the second bond matrix can have a different composition as compared to the first region. The second bond matrix can include a second bond material including an elemental metal, a metal alloy, or a combination thereof. An exemplary metal element can include a transition element as noted in this disclosure. Another exemplary metal can include iron, tungsten, cobalt, nickel, chromium, titanium, silver, tin, zinc, copper, manganese, aluminum, zirconium, niobium, tantalum, vanadium, molybdenum, palladium, gold, cadmium, indium, or a combination thereof. In a particular embodiment, the second bond material can include an alloy including any of the elements noted in embodiments herein. For instance, an exemplary alloy can include iron. In instances, the alloy may include a non-metal element, such as carbon, silicon, sulfur, a phosphorus, or combination thereof. In particular instances, the alloy can include iron, carbon, chromium, manganese, silicon, vanadium, molybdenum, tungsten, or any combination thereof. In another particular embodiment, the second bond material can be different from the first bond material.

The second bond matrix can further include a second infiltrant material that can be the same or different from the first infiltrant material. In an aspect, the second infiltrant can include an elemental metal, a metal alloy, or a combination thereof. The second infiltrant can have a different composition than the second bond material. In a further aspect, the second infiltrant can include a metal element or a metal alloy that has a lower melting temperature than the second bond material. For instance, the second infiltrant material can have a melting point that may not be greater than 80% of the melting point of the second bond material, such as not greater than 75% or not greater than 70% or not greater than 65% or not greater than 50% of the melting point of the second bond material. In another instance, the second infiltrant material can include silver, iron, copper, tin, zinc, aluminum, cobalt, manganese, nickel, phosphorus, chromium, gold, silicon, indium, titanium, boron, vanadium, or any combination thereof. In still another instance, a silver-based alloy, such as AgCu, AgCuMn, AgCuZn, AgCuTi, AgCuln, AgTi, may be used as the first infiltrant material. In still another instance, a silver-based alloy, such as AgCu, AgCuMn, AgCuZn, AgCuTi, AgCuln, AgTi, may be used as the first infiltrant material. In still another instance, a copper-based alloy, such as brass or bonze, may be used as a second infiltrant material. In still another instance, an iron-based alloy, such as FeCuCr, FeCuCrSn, may be used as the first infiltrant material. In still another instance, an aluminum-based alloy, such as AlCuSi, AlCuSiSn, may be used as the first infiltrant material. The second bond material and the second infiltrant material can form the second bond matrix.

In an embodiment, the second bond matrix can include Co, Fe, Cu, Sn, or any combination thereof. In a particular embodiment, the second bond matrix can include Co, Sn, or a combination thereof. In another embodiment, the second bond matrix can include a Co-containing material. In one embodiment, the second bond matrix can include a Co-containing material and a transition metal element that is distinct from cobalt. In certain instances, the second bond matrix can include an alloy material including a combination of at least two of Co, Fe, Cu, and Sn. In a particular embodiment, the second bond matrix can consist essentially of Co and Sn.

In still another embodiment, the second bond matrix can include an impurity, such as C, Ca, Cl, Na, O, or a combination thereof, and the total concentration of all the impurities may not be greater than 1%, such as not greater than 0.5%.

According to one aspect, the second bond matrix can include a particular concentration of Sn that can facilitate improved formation and properties of the core drill bit. For example, the concentration of Sn can be at least 1% Sn for a total weight of the second bond matrix, such as at least 1.2%, at least 1.5%, at least 2.5%, at least 3%, at least 3.5% or at least 4.5%. In another embodiment, the second bond matrix can include at most 24% of Sn for a total weight of the second bond matrix, such as at most 23%, at most 22%, at most 21%, at most 20%, at most 19%, at most 18%, at most 17%, at most 16%, at most 15%, at most 14%, at most 13%, at most 12%, at most 11%, at most 10%, at most 9%, at most 8.5%, at most 7.5%, at most 7%, at most 6.5%, at most 5.5%, at most 4.5%, at most 3.5%, or at most 3% of Sn for a total weight of the second bond matrix. It is to be understood that the concentration of Sn in the second bond matrix can be within a range including any of the minimum and maximum percentages disclosed herein. For instance, the second bond matrix can include Sn in a concentration within a range including at least 1% to not greater than 24%.

According to one aspect, the second bond material can include a particular concentration of Co that can facilitate improved formation and properties of the core drill bit. For example, the concentration of Co can be at least 60% for a total weight of the second bond matrix, such as at least 90%, at least 95%, or at least 97%. In another embodiment, the second bond matrix can include at most 99% of Co for a total weight of the second bond matrix, such as at most 97%, at most 95%, at most 90%, at most 85%, at most 75%, at most 70%, or at most 65% of Co for a total weight of the second bond matrix. It is to be understood that the concentration of Co in the second bond matrix can be within a range including any of the minimum and maximum percentages disclosed herein. For instance, the second bond matrix can include Co in a concentration within a range including at least 60% to not greater than 99%.

In an embodiment, the second region can include a particular second concentration of the second bond matrix that can facilitate improved formation, properties, and/or operation of the core drill bit. For instance, the second bond matrix concentration can be at least 75% for a total weight of the second region, such as at least 80%, at least 85% or at least 90%. In another embodiment, the second region can include a second bond matrix concentration of not greater than 99% for a total weight of the second region, such as not greater than 95%, not greater than 92%, or not greater than 90%. In a further embodiment, the second bond matrix concentration may be different than or the same as the first bond matrix concentration. It is to be understood that the second bond matrix concentration can be within a range including any of the minimum and maximum percentages noted herein. For instance, the second bond matrix concentration can be within a range including at least 70% and not greater than 99%, such as within a range including at least 90% and at most 99%.

In an embodiment, the second region can include a different bond matrix concentration compared to the first region. In an aspect, the second region can include a greater second bond matrix concentration compared to the first region. For instance, a relative difference of the bond matrix concentrations between the first and second regions can be at least 5%, such as at least 8%, at least 10%, at least 12%, at least 15%, at least 20%, at least 23%, at least 25%, or at least 28%. In another instance, the relative difference of the bond matrix concentrations between the first and second regions may be not greater than 50%, not greater than 45%, not greater than 40%, not greater than 35%, not greater than 30%, or not greater than 25%. Moreover, the relative difference of the bond matrix concentrations between the first and second regions can be in a range including any of the minimum and maximum percentages noted herein.

As used in this disclosure, a relative difference is determined by the formula, dᵣ=[|x−y|/max(|x|,|y|)]×100%, where dᵣ is the relative difference, x and y represents values or percentages of a characteristic that is being compared. For instance, for a relative difference in the bond matrix concentration between the first and second regions, x and y are the bond matrix concentrations of the first and second regions, respectively.

In an embodiment, the second region can include a particular second content of the second bond material that can facilitate improved formation and properties of the core drill bit. For instance, the second region can include at least 5 vol % of the second bond material for the total volume of the second region, such as at least 6 vol %, at least 7 vol %, at least 8 vol %, at least 9 vol %, at least 10 vol %, at least 11 vol %, at least 12 vol %, at least 13 vol %, at least 14 vol %, at least 15 vol %, at least 16 vol %, at least 17 vol %, at least 18 vol %, at least 19 vol %, at least 20 vol %, at least 21 vol %, at least 22 vol %, at least 23 vol %, at least 24 vol % of the second bond material for the total volume of the second region. In another instance, the second region may include not greater than 45 vol % of the second bond material for the total volume of the second region, such as not greater than 42 vol %, not greater than 40 vol %, not greater than 39 vol %, not greater than 38 vol %, not greater than 37 vol %, not greater than 36 vol %, not greater than 35 vol %, not greater than 34 vol %, not greater than 33 vol %, not greater than 32 vol %, not greater than 31 vol %, not greater than 30 vol %, not greater than 29 vol %, not greater than 28 vol %, not greater than 27 vol %, not greater than 26 vol %, not greater than 25 vol %, not greater than 24 vol %, not greater than 23 vol %, not greater than 22 vol %, not greater than 21 vol %, not greater than 20 vol %, not greater than 19 vol %, not greater than 18 vol %, not greater than 17 vol %, not greater than 16 vol %, or not greater than 15 vol % of the second bond material for the total volume of the second region. Moreover, the second content of the second bond material can be in a range including any of the minimum and maximum values noted herein, such as in a range from 5 vol % to 45 vol % for the volume of the second region.

In a particular embodiment, the second content of the second bond material can be different from the first content of the first bond material. For instance, a relative difference between the first and second bond material contents can be at least 2%, at least 5%, at least 8%, at least 10%, at least 15%, or at least 20%. In another instance, relative difference between the contents of the first and second bond materials may be not greater than 50%, such as not greater than 40%, not greater than 30%, not greater than 25%, not greater than 20%, or not greater than 15%. Moreover, the relative difference between the first and second contents of the bond materials can be in a range including any of the minimum and maximum percentages noted herein.

In an embodiment, the second region can include a particular second content of the second infiltrant material that can facilitate improved formation and properties of the core drill bit. For instance, the second region can include at least 15 vol % of the second infiltrant material for the total volume of the second region, such as at least 16 vol %, at least 18 vol %, at least 20 vol %, at least 22 vol %, at least 25 vol %, at least 26 vol %, at least 28 vol %, at least 30 vol %, at least 31 vol %, at least 33 vol %, at least 35 vol %, at least 37 vol %, at least 39 vol %, at least 40 vol %, at least 41 vol %, at least 42 vol %, at least 43 vol %, at least 44 vol %, at least 45 vol %, at least 46 vol % at least 47 vol %, at least 48 vol %, at least 49 vol %, at least 50 vol %, at least 51 vol %, at least 52 vol %, at least 53 vol %, at least 54 vol %, or at least 55 vol % of the second infiltrant material for the total volume of the second region. In another instance, the second region may include not greater than 75 vol % of the second infiltrant material for the total volume of the second region, such as not greater than 72 vol %, not greater than 70 vol %, not greater than 69 vol %, not greater than 68 vol %, not greater than 67 vol %, not greater than 66 vol %, not greater than 65 vol %, not greater than 64 vol %, not greater than 63 vol %, not greater than 62 vol %, not greater than 61 vol %, not greater than 60 vol %, not greater than 59 vol %, not greater than 58 vol %, not greater than 57 vol %, not greater than 56 vol %, not greater than 55 vol %, not greater than 54 vol %, not greater than 53 vol %, not greater than 52 vol %, not greater than 51 vol %, not greater than 50 vol %, not greater than 49 vol %, not greater than 48 vol %, not greater than 47 vol %, not greater than 46 vol %, or not greater than 45 vol % of the second infiltrant material for the total volume of the second region. Moreover, the second content of the second infiltrant material can be in a range including any of the minimum and maximum values noted herein, such as in a range from 15 vol % to 75 vol % for the volume of the second region.

In a particular embodiment, the content of the second infiltrant material can be different than the content of the first infiltrant material. For instance, a relative difference between the contents of the first infiltrant material and the second infiltrant material can be at least 2%, such as at least 5%, at least 10%, at least 15%. In another instance, a relative difference between the contents of the first infiltrant material and the second infiltrant material may be not greater than 30%, not greater than 25%, not greater than 20%, or not greater than 15%. Moreover, the relative difference between the contents of the first infiltrant material and the second infiltrant material can be in a range including any of the minimum and maximum percentages noted herein.

In an embodiment, the second region can include a second filler composition including any filler material or combination thereof noted in this disclosure. In a further embodiment, the second region can include a particular second concentration of the second filler composition that can facilitate improved formation and/or performance of the core drill bit. For instance, the second region can include a second filler composition at a second concentration of at least 0.5% for the total weight of the second region, such as at a second concentration of at least 1%, at least 2%, at least 3%, at least 4%, at least 5%, at least 8%, at least 10%, at least 12%, or at least 15%. In another instance, the filler concentration may be not greater than 25%, such as not greater than 22%, not greater than 20%, not greater than 18%, not greater than 14%, not greater than 10%, not greater than 8%, not greater than 5%, not greater than 4%, not greater than 3%, not greater than 2%, not greater than 1%, not greater than 0.8%, or not greater than 0.5%. Moreover, the second concentration of the second filler composition can be in a range including any of the minimum and maximum percentages noted herein, such as in a range from 0.5% to 25% or in a range from 1% to 5%. In at least one embodiment, the second region may not include a filler.

In a particular embodiment, the second region may include a different filler composition than the first region. In another particular embodiment, the second region can include a different concentration of the filler composition compared to the first region. For instance, the relative difference in the filler concentrations between the first and second regions can be at least 1%, such as at least 2%, at least 5%, at least 7%, or at least 10%. In another instance, the relative difference in the filler concentrations between the first and second regions may be not greater than 20%, such as not greater than 15%, or not greater than 10%. Moreover, the relative difference in the filler concentrations between the first and second regions can be in a range including any of the minimum and maximum percentages noted herein.

In an embodiment, the core drill bit can include an elemental weight percent difference between the composition of the first bond matrix and the second bond matrix. An elemental weight percent difference is the absolute value of the difference in weight concentration of each element contained in the first bond matrix relative to the second bond matrix. By way of example only, in an embodiment, a first bond matrix including 27% of Co, 66% of Fe, and 7% of Cu and a second bond matrix including 97% of Co, and 3% Sn, the elemental weight percent difference between the first region bond matrix composition and the second region bond matrix composition for Co is 70%, for Fe is 66%, for Cu is 7%, and for Sn is 3%. The maximum elemental weight percent difference between the composition of the first bond matrix and the second bond matrix is, accordingly, 70%.

In an embodiment, an elemental weight percent difference between the composition of the first bond matrix and the second bond matrix may be not greater than about 99%, such as not greater than 90%, or not greater than 85%, not greater than 80%, not greater than 75%, or not greater than 70%. In another embodiment, the core drill bit can include an elemental weight percent difference between the compositions of the first bond matrix and the second bond matrix of at least about 1%, such as at least 2%, at least 3%, at least 5%, at least 10%, at least 25%, or at least 35%. It is to be appreciated that an elemental weight percent difference between the compositions of the first bond matrix and the second bond matrix can be within a range including any of the minimum and maximum percentages disclosed herein. For instance, an elemental weight percent difference between the compositions of the first bond matrix and the second bond matrix can be within a range including at least 1% and not greater than 99%.

In an embodiment, the first region can have a first hardness RH₁ and the second region can have a second hardness RH₂. The second hardness RH₂ can be different from the first hardness RH₁. Particularly, the first hardness RH₁ can be greater than the second hardness RH₂. As disclosed herein, the first and second hardness can be measured in accordance with Rockwell hardness scale B, using a load of 100 kgf with a steel sphere indenter having a diameter of 1/16 inches (1.588 mm). In some instances, the first hardness RH₁ can be at least 101 HRB, such as at least 102 HRB. In other instances, RH₁ can be at most 110 HRB, such as at most 107 HRB or at most 105 HRB. It is to be understood that RH₁ can be in a range including any of the minimum and maximum values disclosed herein. For example, RH₁ can be within a range including at least 101 HRB and at most 110 HRB. In another embodiment, RH₂ can be at least 95 HRB, such as at least 97 HRB or at least 98 HRB. In a further embodiment, RH₂ may be not greater than 101 HRB, such as not greater than 99 HRB. It is to be understood that RH₂ can be in a range including any of the minimum and maximum values disclosed herein. For example, RH₂ can be within a range including at least 97 HRB and at most 101 HRB.

In some instances, RH₁ and RH₂ can be measured in accordance with the Vickers hardness test, using a load of 200 g with a pyramidal diamond indenter. Accordingly, in some embodiments, RH₁ can have a Vickers hardness of at least 260 HV, such as at least 265 HV, at least 269 HV, at least 271 HV, or at least 273 HV. In some other embodiments, RH₁ can have a Vickers hardness of at most 298 HV, such as at most 295 HV, at most 292 HV, or at most 286 HV, or at most 284 HV. It is to be understood that RH₁ can have a Vickers hardness in a range including any of the minimum and maximum values disclosed herein. For example, RH₁ can be within a range including at least 260 HV and at most 298 HV.

In some embodiments, RH₂ can have a Vickers hardness of at least 210 HV, such as at least 215 HV, at least 218 HV, at least 221 HV, at least 225 HV, at least 228 HV, or at least 232 HV. In some other embodiments, RH₂ can have a Vickers hardness of at most 268 HV, such as at most 265 HV, at most 262 HV, or at most 260 HV, at most 258 HV or at most 256 HV. It is to be understood that RH₂ can have a Vickers hardness in a range including any of the minimum and maximum values disclosed herein. For example, RH₂ can be within a range including at least 210 HV and at most 268 HV. After reading this disclosure, a skilled artisan would understand the first and second hardness can be measured by Rockwell hardness scale B or Vickers hardness, as desired or suitable to a particular application.

In an embodiment, the second region can include a second type of abrasive particles. The second type of abrasive particles can include the same or a different material, as compared to the first type of abrasive particles. For instance, the second type of abrasive particles can include a superabrasive material including diamond, cubic boron nitride (cBN), or any combination thereof. In a particular embodiment, the superabrasive material can consist of diamond, cubic boron nitride (cBN), or any combination thereof. In another embodiment, the abrasive particles can include a material including oxides, carbides, nitrides, or any combination thereof. For instance, the second type of abrasive particles can include diamond, alumina, silicon carbide, boron nitride, or any combination thereof. In at least one embodiment, the second type of abrasive particles can include a different material compared to the first type of abrasive particles. In another embodiment, the second type of abrasive particles can include shaped abrasive particles. In an exemplary implement, the first region can include abrasive particles including diamond, and the second region can include abrasive particles including a material other than diamond. For instance, the second region can include abrasive particles including alumina. In another exemplary implement, the second type of abrasive particles can include differently shaped abrasive particles compared to the first type of abrasive particles.

In an embodiment, the second region can include abrasive particles having a second average particle size of at least 20 microns, such as at least 30 microns, at least 35 microns, at least 40 microns, at least 45 microns, at least 50 microns, at least 55 microns, at least 60 microns, at least 70 microns, at least 80 microns, at least 85 microns, at least 95 microns, at least 100 microns, at least 125 microns, at least 140 microns, at least 160 microns, at least 190 microns, or at least 210 microns. In another embodiment, the second average particle size can be at most 310 microns, such as at most 280 microns, at most 250 microns, at most 220 microns, at most 200 microns, at most 170 microns, at most 150 microns, at most 145 microns, at most 120 microns, at most 110 microns, at most 105 microns, at most 100 microns, at most 95 microns, at most 90 microns, at most 85 microns, at most 80 microns, at most 75 microns, at most 70 microns, at most 65 microns, at most 60 microns, at most 50 microns, at most 45 microns, at most 40 microns It is to be appreciated that the abrasive particles in the second region can have a second average particle size within a range including any of the minimum and maximum values disclosed herein. For instance, the second average particle size of the abrasive particles within the second region can be within a range including at least 20 microns and at most 310 microns or within a range including at least 30 microns and at most 150 microns.

In a particular embodiment, the first region can include a first average particle size that is different from the second average abrasive particle size of the second region. For example, the abrasive particles contained in the first region can include coarse particles, and the abrasive particles contained in the second region can include fine particles. In another instance, the first average particle size of the first region can be greater than the second average particle size of the second region. For instance, a relative difference in average particle sizes between the first region and the second region can be at least 5%, at least 7%, at least 10%, at least 12%, at least 15%, or at least 20%. In another instance, the relative difference in average particle sizes between the first region and the second region may be not greater than 50%, such as not greater than 45%, not greater than 40%, not greater than 35%, not greater than 30%, not greater than 25%, or not greater than 20%. In another instance, the relative difference in average particle sizes between the first region and the second region can be in a range include any of the minimum and maximum percentages noted herein.

In a further embodiment, the second region can include a particular second abrasive particle concentration that can facilitate improved formation, properties and/or operation of the core drill bit. For example, the second region can include a second abrasive particle concentration of at least about 1% for a total weight of the second region, such as at least about 2%, at least about 4%, at least about 5%, at least 7%, at least 9%, or at least 10%. In a further embodiment, the second region may include a second abrasive particle concentration of not greater than about 15% for a total weigh of the second region, such as not greater than about 13%, not greater than 11%, not greater than about 9%, not greater than about 8%, not greater than about 6%, not greater than about 4%. It is to be understood that the second region can include a second abrasive particle concentration within a range including any of the minimum and maximum percentages noted herein. For instance, the second abrasive particle concentration can be within a range including at least 1% and not greater than 15% for a total weight of the second region.

In another embodiment, the second region can include a different concentration of the abrasive particles compared to the first region. In an aspect, the first region can include a higher concentration of abrasive particles compared to the second region. For instance, a relative difference in the concentrations of abrasive particles between the first and second regions can be at least 3%, such as at least 5% or at least 7%. In another instance, the relative difference in the concentrations of abrasive particles between the first and second regions may be not greater than 15%, such as not greater than 12% or not greater than 10%. Moreover, the relative difference in the concentrations of abrasive particles between the first and second regions can be in a range including any of the minimum and maximum percentages noted herein. In another aspect, the second region may include a higher concentration of abrasive particles compared to the first region.

In an embodiment, the second region can include a second type of pores including closed pores, interconnected pores, or any combination thereof. In a particular embodiment, the second region can include a different type of pores compared to the first region.

In an embodiment, the second region can have a particular second porosity that can facilitate improved formation, properties, and/or operation of the core drill bit. The porosity of the second region may be the same as or different than that of the first region. In an embodiment, the second region can have a porosity of at least 0.1 vol % for a total volume of the second region, such as at least 0.3 vol %, at least 0.5 vol %, at least 0.9 vol %, at least 1.5 vol %, at least 2 vol %, at least 4 vol %, at least 5 vol %, at least 8 vol %, at least 10 vol %, or at least 13 vol % for a total volume of the second region. In another embodiment, the second region may have a porosity of not greater than 40 vol % for a total volume of the second region, such as not greater than 35 vol %, not greater than 30 vol %, not greater than 25 vol %, not greater than 20 vol %, not greater than 15 vol %, not greater than 10 vol %, not greater than 9 vol %, or not greater than 8 vol %. It is to be understood that the second region can include a porosity within a range including any of the minimum and maximum percentages disclosed herein. For instance, the second region can have a porosity within a range including at least 0.1 vol % to not greater than 40 vol %, or within a range including at least 0.1 vol % and not greater than 10 vol % for a total volume of the second region.

In an embodiment, the second porosity of the second region can be different than the first porosity of the first region. In an aspect, the second region may include a higher porosity than the first region. For instance, a relative difference of porosity between the first and second region can be at least 2%, such as at least 5% or at least 7%. In another instance, the relative difference between of porosity between the first and second region may be not greater than 40%, not greater than 30%, not greater than 20%, or not greater than 10%. Moreover, the relative difference of porosity between the first and second region can be in a range including any of the minimum and maximum percentages noted herein. In another aspect, the first region may be more porous than the second region.

In an embodiment, the second region can include a second pore size distribution including a second D₁₀, a second D₅₀, a second D₉₀, or any combination thereof. In an embodiment, the second region can include a particular second D₁₀ that can facilitate improved formation, properties, and/or operation of the core drill bit. In an aspect, the second D₁₀ may be at least 0.001 microns, at least 0.005 microns, at least 0.01 microns, at least 0.05 microns, at least 0.1 microns, at least 0.2 microns, such as at least 0.5 microns, at least 0.8 microns, at least 1 micron, at least 1.3 microns, at least 1.5 microns, at least 2 microns, at least 2.5 microns, at least 3 microns, at least 4 microns, at least 5 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, or at least 95 microns. In another aspect, the second D₁₀ may be at most 310 microns, such as at most 300 microns, at most 290 microns, at most 280 microns, at most 270 microns, at most 250 microns, at most 230 microns, at most 210 microns, at most 180 microns, at most 150 microns, at most 130 microns, at most, 110 microns, at most 100 microns, at most 90 microns, at most 70 microns, at most 50 microns, at most 30 microns, at most 10 microns, at most 8 microns, or at most 5 microns. In a further aspect, the second region can include the second D₁₀ in a range including any of the minimum and maximum values noted herein. In particular instances, the first D₁₀ can be different than the second D₁₀.

In another embodiment, the second region may include a particular average pore size (D₅₀) that may facilitate improved formation, properties, and/or operation of the core drill bit. In an aspect, the average pore size may be at least 5 microns, such as at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, at least 100 microns, or at least 110 microns. In another aspect, the average pore size may be at most 400 microns, at most 350 microns, such as at most 330 microns, at most 310 microns, at most 300 microns, at most 290 microns, at most 270 microns, at most 250 microns, at most 230 microns, at most 210 microns, at most 180 microns, or at most 150 microns. In a further aspect, the first region can include an average pore size in a range including any of the minimum and maximum values noted herein.

In a further embodiment, the first average pores size of the first region may be different than the second average pore size of the second region. In an aspect, the first region can include a greater average pore size than the second region. In another aspect, the first region can include a smaller average pore size than the second region. In a further aspect, the core drill bit can include a relative difference in the average pore size between the first and second regions. For instance, the relative difference in the average pore size between the first and second regions can be at least 5%, such as at least 8%, at least 11%, at least 15%, at least 18%, or at least 20%. In another instance, the relative difference in the average pore size between the first and second regions may be not greater than 50%, such as not greater than 40%, not greater than 35%, not greater 30%, or not greater than 20%. Moreover, the relative difference in the average pore size between the first and second regions can be in a range including any of the minimum and maximum percentages noted herein.

In an embodiment, the second region can include a particular second D₉₀ that may facilitate improved formation, properties, and/or operation of the core drill bit. For instance, the second D₉₀ can be at least 0.06 microns, at least 0.1 microns, at least 0.2 microns, such as at least 0.5 microns, at least 0.8 microns, at least 1 micron, at least 1.3 microns, at least 1.5 microns, at least 2 microns, at least 2.5 microns, at least 3 microns, at least 4 microns, at least 5 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, at least 100 microns, at least 110 microns, at least 130 microns, at least 150 microns, at least 180 microns, or at least 200 microns. In another instance, the second D₉₀ may be at most 480 microns, at most 440 microns, at most 400 microns, at most 350 microns, such as at most 330 microns, at most 310 microns, at most 300 microns, at most 290 microns, at most 270 microns, at most 250 microns, at most 230 microns, at most 210 microns, at most 180 microns, at most 150 microns, at most 130 microns, at most, 110 microns, at most 100 microns, at most 90 microns, at most 70 microns, at most 50 microns, at most 30 microns, at most 10 microns, at most 8 microns, or at most 5 microns. Moreover, the second D₉₀ can be in a range including any of the minimum and maximum values noted herein. In particular instances, the second region can include the second D₉₀ different the first D₉₀.

In an embodiment, the abrasive tip can define an exterior surface region of the core drill bit. In a material removal operation, the exterior surface region of the core drill bit can be in contact with the workpiece. In another embodiment, the abrasive tip can consist of the first and second regions. In a further embodiment, the first and the second regions can define an exterior surface region of the drill bit, and more particularly both the first and second regions can define different exterior surface regions of the body of the core drill bit. The first and second regions can define exterior surface of the body of the abrasive tip and are configured to contact a workpiece during a material removal operation.

As illustrated in FIG. 1, a longitudinal axis 150 extends along and defines a length, L, of the core drill bit 100. The core drill bit 100 can include a central opening 106 extending in the direction of the longitudinal axis 150. As illustrated, the opening 106 can extend through the first region 101, the second region 102, and the body 120. The opening 106 can further extend through the shaft 130 (not illustrated) to allow coolant to flow through the drill bit in operations.

As illustrated in FIG. 1, the first region can define a ring-shaped element. Accordingly, the first region can have an annular cross-section about the longitudinal axis 150. In another embodiment, the second region 102 can have an annular cross-section about the longitudinal axis 150. In a particular embodiment, both the first and second regions can have an annular cross-section about the longitudinal axis 150.

FIG. 2 includes an illustration of an annular cross-sectional view of the first region 101 of the core drill bit 100. The opening 106 is at the center of the first region 101. The first region can have a first inner diameter dᵢₙ₁ and an outer diameter dₒ. The first inner diameter (dᵢₙ₁) can be substantially uniform through a thickness of the first region that extends in the direction of the longitudinal axis 150. The outer diameter (dₒ) can also be substantially uniform through the thickness of the first region. As used herein, the term, substantially uniform, is intended to mean for a set circumference C₀, a diameter has a maximum deviation of ±20% of the theoretical diameter D₀ for the circumference C₀(C₀=π×D₀).

In an embodiment, the first inner diameter (dᵢₙ₁) can be at least 3.2 mm, such as at least 5 mm, at least 7.5 mm, at least 10 mm, or at least 15 mm. In another embodiment, the first inner diameter may not be greater than 123.2 mm, such as not greater than 115 mm, not greater than 105 mm, not greater than 95 mm, not greater than 80 mm, or not greater than 75 mm. It is to be appreciated that the first inner diameter can be within a range including any of the minimum and maximum values noted herein. For example, the first inner diameter can be within a range including at least 2.2 mm and not greater than 123.2 mm.

In an embodiment, the first region can have an outer diameter (dₒ) of at least 5 mm, such as at least 6.5 mm, at least 8 mm, at least 10 mm, at least 15 mm, or at least 18 mm. In another embodiment, the first region may have an outer diameter of not greater than 125 mm, such as, not greater than 120 mm, not greater than 115 mm, not greater than 110 mm, not greater than 105 mm, not greater than 90 mm, not greater than 80 mm, not greater than 75 mm, not greater than 65 mm, not greater than 60, not greater than 55 mm. It is to be appreciated that the first region can have an outer diameter within a range including any of the minimum and maximum values noted herein. For example, the first region can have an outer diameter within a range including at least 5 mm and not greater than 125 mm.

In an embodiment, the first region can be bonded to the second region. In a further embodiment, the first region and the second region can be bonded by co-sintering and interdiffusion of the first bond matrix or infiltrant and the second bond matrix or infiltrant. In another embodiment, the core drill bit can include a joint region connecting the first region and the second region. For instance, the joint region can include a bond matrix including a mixture of the first bond matrix and the second bond matrix. In one embodiment, the joint region can include abrasive particles, such as those from the first region, the second region, or both.

In a further embodiment, the joint region can include an interfacial layer. The interfacial layer can define a region of bond matrix material having element from both the first and second bond matrix materials. The interfacial layer can define a co-sintered boundary between the first and second regions. In at least one embodiment, the interfacial layer can define a region of interdiffusion of elements from the first and second bond matrix or infiltrant materials.

In an embodiment, the first region can include a hollow core cutting element. The hollow core cutting element can include abrasive grains within a bond matrix. In a particular embodiment, the first region can define a hollow core cutting element. In a further embodiment, the hollow core cutting element can be ring-shaped.

In another embodiment, the second region can include a seamer element, which can be connected to the core cutting element. In a particular embodiment, the second region can define a seamer element. The seamer element can include abrasive grains within a bond matrix. In an embodiment, the seamer element and the core cutting element can include the same or different compositions. For instance, the seamer element and the core cutting element can include different compositions. In a particular embodiment, the matrices of the core cutting element and the seamer element can include different compositions.

Referring to FIG. 3, an annular cross-sectional view of the second region 102 of the core drill bit 100 is included. The opening 106 can be at the center of the second region and have an inner diameter dᵢₙ₂. Dᵢₙ₂ can be the same as dᵢₙ₁. In certain designs, dᵢₙ₂ of the second region can be different compared to dᵢₙ₁ of the first region.

In an embodiment, the second inner diameter (dᵢₙ₂) can be at least 3.2 mm, such as at least 3.5 mm, at least 4.5 mm, at least 5.5 mm, or at least 7 mm. In another embodiment, the second inner diameter may not be greater than 123.2 mm, such as not greater than 115 mm, not greater than 105 mm, not greater than 95 mm, or not greater than 90 mm. It is to be appreciated that the second inner diameter can be within a range including any of the minimum and maximum values noted herein. For example, the second inner diameter can be within a range including at least 3.2 mm and not greater than 123.2 mm.

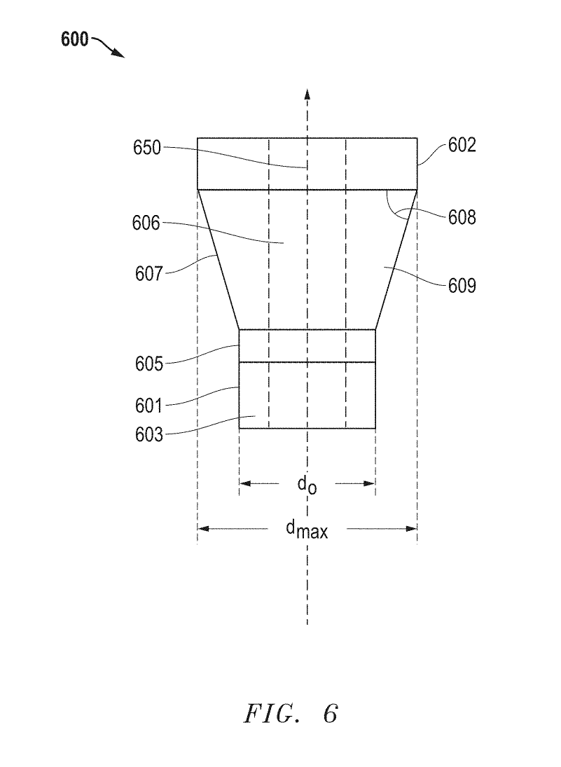

FIG. 6 includes an enlarged illustration of a side view of a portion of a core drill bit 600. The core drill bit 600 can include a first region 601, a joint region 605, and a second region 602. A central opening 606 can extend through the first region 601 and second region 602 in the direction of the longitudinal axis 650. In an embodiment, the joint region 605 can have an annular cross-sectional view about the longitudinal axis 650.

The first region 601 can include a hollow core cutting element 603, and the second region can include a seamer 609. The seamer can include a chamfer 607 and a seamer angle 608. In an embodiment, the seam angle can be at least 45 degrees, such as at least 46 degrees, at least 47 degrees or at least 48 degrees. In another embodiment, the seamer angle may be not greater than 55 degrees, such as not greater than 53 degrees, not greater than 52 degrees, or not greater than 51 degrees. In a further embodiment, the seamer angle can be within a range including any of the minimum and maximum values disclosed herein. For instance, the seamer angle can be within a range including at least 45 degrees and not greater than 55 degrees.

The second region can have a maximum outer diameter, dₘₐₓ. The maximum outer diameter of the second region dₘₐₓ can be greater than the outer diameter dₒ of the first region. In an embodiment, the maximum outer diameter (dₘₐₓ) can be at least 2 mm greater than the outer diameter of the first region (dₒ), such as at least 3 mm greater than dₒ, at least 4 mm greater than dₒ, or at least 6 mm greater than dₒ.

In an embodiment, the second region can have a maximum outer diameter dₘₐₓ of at least about 7 mm, such as, at least about 9 mm, at least 10.5 mm, at least 12 mm, or at least 16 mm. In another embodiment, the second region may have a maximum outer diameter dₘₐₓ of not greater than 250 mm, such as not greater than 230 mm, not greater than 210 mm, not greater than 200 mm, or not greater than 180 mm. It is to be appreciated that the maximum outer diameter dₘₐₓ of the second region can be within a range including any of the minimum and maximum values noted herein. For instance, the maximum outer diameter dₘₐₓ can be within a range including at least 7 mm and not greater than 250 mm. In some applications, the maximum outer diameter (dₘₐₓ) of the second region can be different than the values or ranges noted herein, and formed as desired by any particular application.

The core drill bit can have an improved service life. In an embodiment, the core drill bit can be expected to form more holes in its service life in the same drilling condition and glass workpieces, as compared to a conventional core drill bit. For instance, the core drill bit can form at least 3200 holes in drilling conditions that a core drill bit is normally expected to operate in, such as at least 4000 holes, at least 5000 holes, at least 5500 holes, or at least 6000 holes. In another embodiment, the core drill bit may not form more than 10000 holes.

In a further embodiment, the core drill bit can include a certain wear rating. As disclosed herein, the wear rating is measured using the conditions disclosed herein. The workpiece is a piece of glass having thickness of 4 mm. A pair of two drill bits is used with a TAC drilling machine and to form 480 holes having the diameter of 11.5 mm. A drill bit is used to drill from the bottom of the glass and through half of the thickness of the glass. The other is then used to drill from the top and open the hole. For each drilling, the drill bit is operated at a speed of 6000 rpm. The first region has a feed speed of 80 mm/min, and the second region has a feed speed of 40 mm/min. After forming 480 holes, the worn off length of the bottom core drill bit is measured as wear rating. In an embodiment, the core drill bit can include a wear rating of not greater than about 0.09 mm, such as, not greater than about 0.085 mm, not greater than about 0.08 mm, not greater than about 0.075 mm, not greater than about 0.07 mm, not greater than about 0.065 mm, or not greater than about 0.06 mm. In another embodiment, the core drill bit can include a wear rating greater than 0. A skilled artisan would understand that in different drilling conditions, the wear rating of a core drill bit can change.

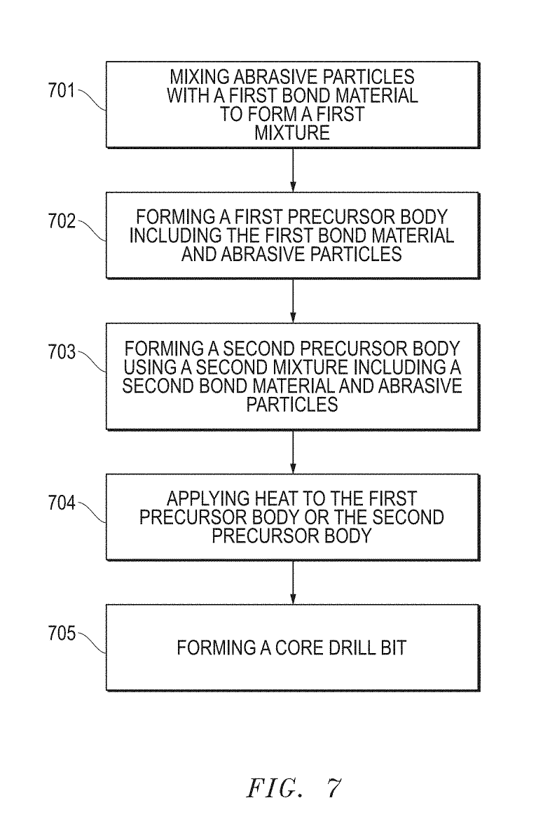

In an embodiment, formation of the core drill bit can include an additive manufacturing process. FIG. 7 includes a flowchart illustrating a process of forming a core drill bit in accordance with embodiments herein. As illustrated, the process can start at the block 701, where a first mixture including abrasive particles and a first bond material can be prepared. The first mixture can be in the form of powder including abrasive particles and particles of the first bond material. The first bond material and the first infiltrant material can form the first bond matrix in a finally formed core drill bit.

In another embodiment, the mixture can include a content of the abrasive particles (C_{AP1}) for the total weight of the first mixture, and include a content of the first bond material (C_{B1}) for the total weight of the first mixture, and further include a particular ratio (C_{AP1}:C_{B1}), such as in a range from 0.05:1 to 0.15:1, that can facilitate improved formation of the core drill bit. In some instances, the mixture can optionally include an additive, such as a filler material. An exemplary filler material can include an oxide, a carbide, a nitride, a sulfide, or any combination thereof. In an embodiment, the filler material can include tungsten carbide, silicon carbide, alumina, or any combination thereof. The filler material is different from the abrasive particles by hardness, composition, particle size, or any combination thereof. Suitable mixing operations can be utilized to achieve homogenous dispersion of the components within the mixture.

At the block 702, forming the first precursor body can be performed using the first mixture. It will be appreciated that reference to a precursor body includes a body that is not finally-formed and may undergo further processes, such as through a heating process or a pressing process, to form a finally formed body. In an embodiment, forming the first precursor body can include an additive manufacturing process. An exemplary additive manufacturing process can include selective laser sintering, binder jetting, stereolithography, direct metal laser sintering, electron beam melting, concept laser cusing, selective laser melting, laser powder injection, laser engineered net shaping, direct metal deposition, laser consolidation, free form fabrication, electron beam free form fabrication, plasma transferred arc-selective free form fabrication, ion fusion formation, shaped metal deposition, ultrasonic additive manufacturing, or any combination thereof. In a particular aspect, the additive manufacturing process can include selective laser sintering, binder jetting, stereolithography, or any combination thereof.

In an exemplary forming process, the first precursor body can be formed in a layer-by-layer manner. In an aspect, the first precursor body can include a stack of a plurality of first layers, wherein each first layer includes a portion of the first mixture. In another aspect, the plurality of first layers can be printed sequentially having the similar thickness and composition. In a further aspect, each of the first layers may have a thickness in a range from 40 microns to 600 microns or in a range from 70 microns to 500 microns or in a range from 80 microns to 400 microns.

In a particular embodiment, the first precursor body can be formed by using a binder jetting 3D printer or the like, wherein a binder material can be applied to at least some of the first layers or each first layer, such that at least some of the particles in each layer and neighboring layers can be glued together by the binder material. In an exemplary 3D printing process, the first mixture may be used as the powder supply, and a first layer of the powder can be formed by a recoating blade and distributed on a build platform. A binder material, such as an aqueous-based binder, can be applied to at least a portion of the first layer, by e.g., a nozzle, which can facilitate bonding of the particles. Then the build platform can be lowered by the thickness of the first layer to allow a second layer to be spread over the first layer. After application of the binder material to the second layer, a third layer can be formed. The process can be repeated until the first precursor body is formed. In an embodiment, the first precursor body can be formed having the similar shape to the first region and including compacted powder particles that are glued by the binder material.

In a further embodiment, the first precursor body can include a porosity of at least 30 vol % for the total volume of the first precursor body. In some instances, the porosity can be at least 40 vol %, at least 45 vol % or at least 50 vol %. In another instance, the porosity of the first precursor body may not be greater than 60 vol %, such as not greater than 55 vol % or not greater than 50 vol %. It is to be understood the porosity of the first precursor body can be in a range including any of the minimum and maximum percentages noted herein, such as in a range from 30 vol % to 60 vol %.

In a further embodiment, the first precursor body can include a content of the first bond material (V_{B1}) for the total volume of the first bond material and abrasive particles (e.g., the solid volume of the first precursor body), and include a content of abrasive particles (V_{AP}) for the total volume of the first bond material and abrasive particles. The first precursor body further can include a particular ratio (V_{B1}N_{AP}) that can facilitate improved formation and performance of the core drill bit. For example, the ratio (V_{B1}/V_{AP}) may be not greater than 8, such as not greater than 7, not greater than 6 or not greater than 5. In another instance, the ratio (V_{B1}N_{AP}) can be at least 2, such as at least 3, at least 4, or at least 5. It is to be understood that the ratio (V_{B1}/V_{AP}) can be in a range including any of the minimum and maximum values noted herein, such as in a range from 2 to 8.

In another embodiment, the first precursor body can include from 26 vol % to 62 vol % of the first bond material for the total volume of the first precursor body, and from 15 vol % to 45 vol % of abrasive particles for the total volume of the first precursor body. In a further embodiment, the first precursor body can include up to 30 vol % of the filler material for the total volume of the first precursor body.

The process can continue to form a second precursor body as illustrated in the block 703. The second mixture used to form the second precursor body can be prepared in the same manner used for forming the first mixture. For instance, the second mixture can include a ratio (C_{AP2}:C_{B2}) of the content of the second bond material (C_{B2}) to the content of abrasive particles (C_{AP2}) in a range from 0.05:1 to 0.15:1. The second mixture can include a second bond material and abrasive particles, wherein both can be in the form of powder. In an embodiment, the second bond material, the content of the second bond material, or a combination thereof can be different from the first bond material. In another embodiment, the second mixture can include different abrasive particles than the first mixture. For instance, the average particle size, the content of the abrasive particles, the material of the abrasive particles, or any combination thereof can be different. The second bond material and an infiltrant material can form the second bond matrix in a finally formed core drill bit. In another embodiment, the second mixture can optionally include a filler material as noted herein. The filler material in the second mixture can be different or the same as the filler in the first mixture.

In an embodiment, the second precursor body can be formed utilizing a process that is similar to the one used for forming the first precursor body, such as an additive manufacturing process, and in particular instances, utilizing a binder jetting machine. For instance, the second precursor body can include a stack of a plurality of second layers, which can be bonded by a bind material. In another embodiment, the second precursor body can be formed having the similar shape to the second region and including compacted powder particles that are glued by the binder material. In a particular embodiment, the first layer of the second precursor body can be formed and distributed over the last layer of the first precursor body such that at least a portion of the first precursor body is attached to the second precursor body, such as by the binder material. In another embodiment, the second precursor body can be formed separately from the first precursor body. The first and second precursor bodies can be joined in a later process.

In a further embodiment, the second precursor body can include a porosity of at least 30 vol % and not greater than 60 vol % for the total volume of the second precursor body. In another embodiment, the second precursor body can include a content of the second bond material from 5 vol % to 35 vol % for the total volume of the second precursor body, and from 15 vol % to 45 vol % of abrasive particles for the total volume of the second precursor body. In a further embodiment, the second precursor body can include up to 30 vol % of the filler material for the total volume of the second precursor body.

The process can continue to the block 704, where heat can be applied to at least a portion of the first precursor body or the second precursor body. In an aspect, applying heat can include applying an infiltrant material to at least one of the first and second precursor bodies. The infiltrant material can include a metal material that is molten. The infiltrant material can take up at least 90% of the total porosity of the precursor body, such as at least 92%, at least 93% or at least 95% of the total porosity, such that a first region or the second region can be formed when infiltration is completed. In another aspect, applying heat can include applying an infiltrant material to both the first and second precursor bodies and joining the first and second precursor bodies. For example, the same infiltrant material can be used to simultaneously infiltrate both the first and second precursor bodies, and particularly, infiltrating the precursor bodies at the same time can facilitate bonding of the bodies by the infiltrant. In still another aspect, infiltrating the first and second precursor bodies can include forming an interfacial layer between the first and second precursor bodies. In yet another aspect, the finally formed first and second regions can be bonded by an interfacial layer, wherein the interfacial layer can include the infiltrant material, or consist essentially of the infiltrant material. In at least one embodiment, prior to performing infiltration, heat can be applied to remove the binder material from the first and second precursor bodies, which may be conducted by placing the precursor bodies in an oven at a temperature from 50° C. to 650° C. for 10 to 120 minutes.

In one embodiment, infiltrating the first and second precursor bodies can be performed separately using the same or different infiltrant material to form the finally formed first region and second region. An additional process may be performed to join the first and second regions if they are formed separately, such as hot pressing, cold isostatic pressing, hot isostatic pressing, welding, brazing, or the like.

In one embodiment, one of the first and second precursor bodies may be formed by a conventional process including, such as forming a mixture including the bond material, infiltrant material, abrasive particles, and optionally a filler, shaping the mixture to form a precursor body having the desired shape, and densifying the precursor body to form the finally formed region. Densification of the precursor body may be conducted by hot pressing, cold isostatic pressing, hot isostatic pressing, or sintering. The finally formed region can be joined to the other region as noted in this disclosure.

The finally formed first and second regions can be connected to a core drill bit body, such as, the body 120 in FIG. 1, by brazing or sintering such that the body is bonded to the second region. A shaft can be screwed to the body or bonded to the body by brazing. The body and the shaft can be formed by methods known in the art, such as machining. The shaft may have the shape as illustrated in FIG. 1 or any shape or geometry to adapt to drilling machines used in the art, such as the shaft 830 of the core drill bit 800 illustrated in FIG. 8. One end of the shaft 830 is connected to the body 820. Alternatively, the body and the shaft can be formed as a single piece and connected to the second region by brazing.

In a further embodiment, the core drill bit body and the shaft can be formed utilizing an additive manufacturing process and subsequently heated as disclosed in embodiments herein. In an aspect, the precursor bodies of the core drill bit body and shaft may be formed separately or in a manner that the precursor bodies are attached or also attached to the second region by a binder material. In another aspect, infiltration may be performed to form the finally formed core drill body or shaft. For instance, a molten infiltrant material noted in embodiments herein can be applied to at least a portion of all of the precursor bodies of the first region, second region, the core drill body, and the shaft such that each component can be densified and at the same time attached to one another by the infiltrant material.

FIG. 9 includes an illustration of a scanning electron image of a cross-section of a core drill abrasive article 900, where the abrasive tip and the core drill body 920 are connected by infiltration. As illustrated, the second region 901 including abrasive particle 902 and a bond matrix 903 is bonded to the core drill body 920 by an interfacial layer 910 that is substantially formed by the infiltrant material.

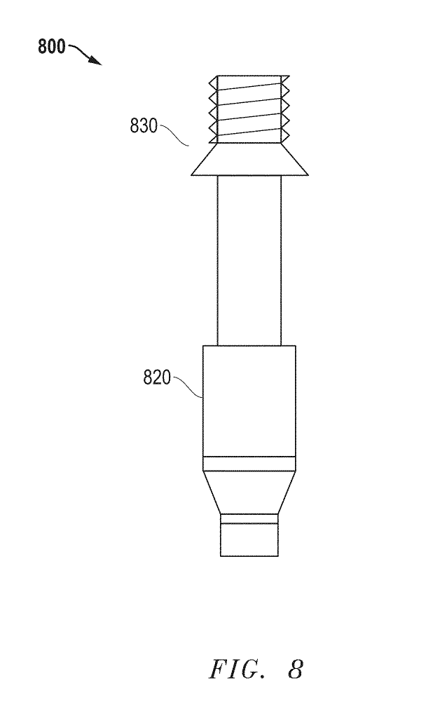

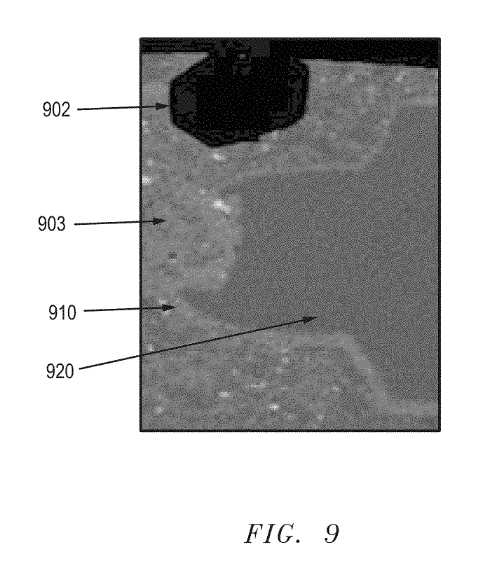

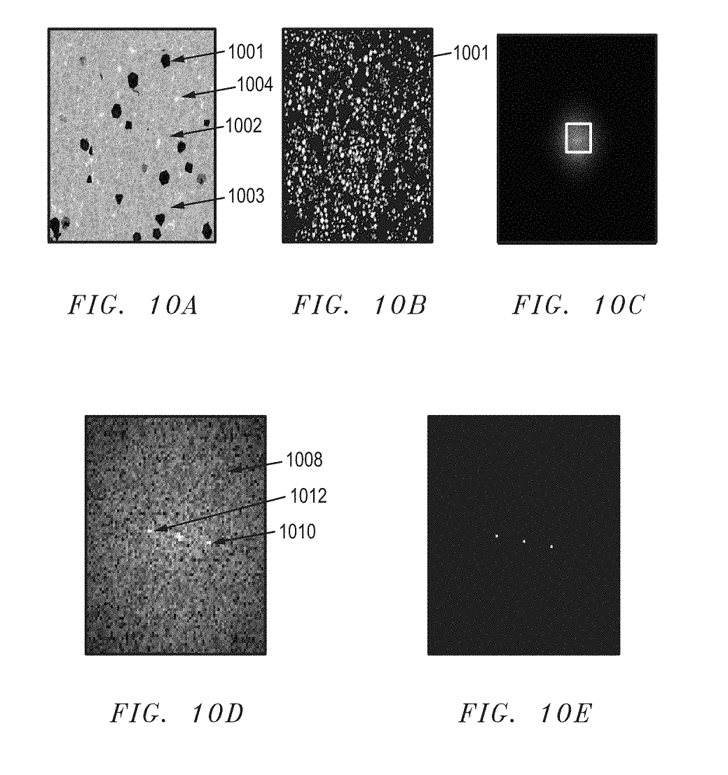

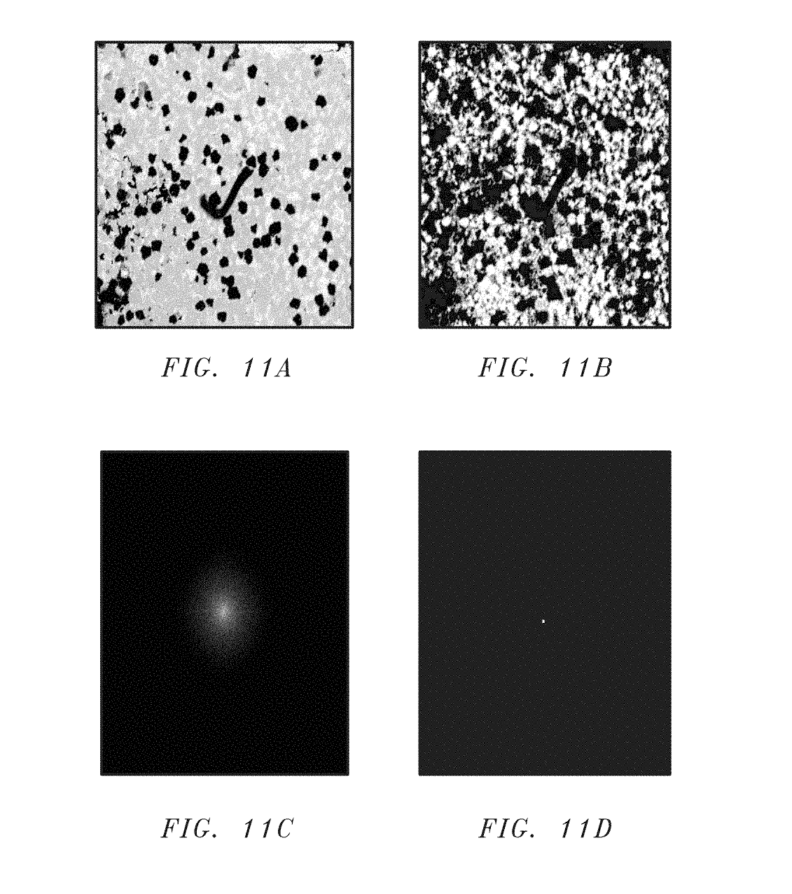

In an embodiment, the first region, the second region, or both can include a Fast Fourier Transform value greater than 1. In a particular embodiment, each of the first and second region can include a Fast Fourier Transform value greater than 1, such as at least 2. In another embodiment, the core drill body or the shaft can include a Fast Fourier Transform value greater than 1, such as at least 2. The Fast Fourier Transform value is determined based on frequency domain images transformed from scanning electron microscopic (SEM) images of at least 3 cross sections of the component of the core drill abrasive article. The cross sections can be ground and polished beforehand. The frequency domain images are obtained by utilizing the Fourier Transform through Python to process the SEM images, which will be further described in below paragraphs in view of FIGS. 10A to 10E and FIGS. 11A to 11D.

FIGS. 10A to 10E include images of a cross section of a first region formed in accordance with embodiments noted herein. FIG. 10A includes a scanning electron microscopic image of the cross section. As illustrated, the first region can include abrasive particles 1001 joined by a bond matrix including a bond material 1002 and an infiltrant material 1003, and a filler material 1004. FIG. 10A can be processed by adjusting the threshold such that the infiltrant, abrasive particles, and filler are excluded from the image of FIG. 10B, in which only the bond material is illustrated. FIG. 10C includes an image that is further processed to focus on the center, the brightest area, of FIG. 10B, and FIG. 10D is a blown-up illustration of the boxed area in FIG. 10C and demonstrates noise 1008 in greyscale and frequency signals 1010 and 1012 that have brightness above the noise. Removing the noise from FIG. 10D, a frequency domain image is generated and illustrated in FIG. 10E. The bright dot in the center is the zero frequency component indicating the average brightness of the image in FIG. 10B, and the other two symmetrically distributed bright dots represent the frequency of the bond material. The Fast Fourier Transform value refers to the average number of dots that appear in addition to the zero frequency component of three cross sections.

FIG. 11A includes a scanning electron microscopic image of a first region formed by hot pressing. FIGS. 11B to 11D demonstrate the images based on FIG. 11A that is processed in the same way that was used to analyze the SEM image of FIG. 10A. As illustrated in FIG. 11D, only the zero frequency component appears in the frequency domain image, which is to be understood that the hot-press-formed first region includes a Fast Fourier value of 0.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### EMBODIMENTS

### Embodiment 1

A core drill bit comprising an abrasive tip and a drill body, wherein the abrasive tip comprises:
a first region comprising abrasive particles contained within a first bond matrix, wherein the first region comprises a Fast Fourier Transform value greater than 1; and
a second region comprising abrasive particles contained within a second bond matrix;
wherein the first region comprises at least one first abrasive characteristic selected from the group of a first bond matrix composition, a first bond matrix concentration, a first bond material content (vol %), a first infiltrant content (vol %), a first average abrasive particle size, a first abrasive particle concentration, a first type of pores, a first average pore size, a first pore size distribution, and a first porosity, a first filler composition, and a first filler concentration;
wherein the second region comprises at least one second abrasive characteristic selected from the group of a second bond matrix composition, a second bond matrix concentration, a second bond material content (vol %), a second infiltrant content (vol %), a second average abrasive particle size, a second abrasive particle concentration, a second type of pores, a second average pore size, a second pore size distribution, a second porosity, a second filler composition, and a second filler concentration; and
wherein at least one first abrasive characteristic is different than at least one corresponding second abrasive characteristic.

### Embodiment 2

A core drill bit comprising an abrasive tip and a drill body, wherein the abrasive tip comprises:
a longitudinal axis running a length of the core drill bit;
a first region comprising abrasive particles contained within a first bond matrix, wherein the first region comprises an annular cross-section about the longitudinal axis of the core drill bit; and
a second region comprising abrasive particles contained within a second bond matrix, wherein the second region comprises an annular cross-section about the longitudinal axis of the core drill bit,
wherein the first region comprises at least one first abrasive characteristic selected from the group of a first bond matrix composition, a first bond matrix concentration, a first bond material content (vol %), a first infiltrant content (vol %), a first average abrasive particle size, a first abrasive particle concentration, a first type of pores, a first average pore size, a first pore size distribution, and a first porosity, a first filler composition, and a first filler concentration;
wherein the second region comprises at least one second abrasive characteristic selected from the group of a second bond matrix composition, a second bond matrix concentration, a second bond material content (vol %), a second infiltrant content (vol %), a second average abrasive particle size, a second abrasive particle concentration, a second type of pores, a second average pore size, a second pore size distribution, a second porosity, a second filler composition, and a second filler concentration;
wherein at least one first abrasive characteristic is different than at least one corresponding second abrasive characteristic; and wherein at least one of the first region and the second region has a Fast Fourier Transform value greater than 1.

### Embodiment 3

A core drill bit comprising an abrasive tip and a drill body, wherein the abrasive tip comprises:
a first region and a second region, wherein the first region comprises abrasive grains within a first bond matrix, wherein the second region comprises abrasive grains within a second bond matrix and wherein a composition of the first bond matrix is different from a composition of the second bond matrix; and
wherein the first region comprises a Fast Fourier Transform value greater than 1.

### Embodiment 4

A core drill bit comprising:
a longitudinal axis running the length of the drill bit;
a first region comprising abrasive grains within a first bond matrix; and
a second region comprising abrasive grains within a second bond matrix,
wherein the first region comprises an annular cross-section about the longitudinal axis of the drill bit, wherein the second region comprises an annular cross-section about the longitudinal axis of the drill bit, and wherein a composition of the first bond matrix is different from a composition of the second bond matrix; and
wherein at least one of the first region and the second region has a Fast Fourier Transform value greater than 1.

### Embodiment 5

A core drill bit comprising:
a hollow core cutting element comprising abrasive grains within a first bond matrix;
a seamer element connected to the core cutting element and comprising abrasive grains within a second bond matrix;
wherein a composition of the first bond matrix is different from a composition of the second bond matrix; and
wherein at least one of the hollow core cutting element and the seamer element comprises a Fast Fourier Transform value greater than 1.

### Embodiment 6

The core drill bit of embodiment 5, wherein each of the hollow core cutting element and the seamer comprises a Fast Fourier Transform value greater than 1.

### Embodiment 7

The core drill bit of any one of embodiments 1 to 4, wherein each of the first region and the second region comprises a Fast Fourier Transform value greater than 1.

### Embodiment 8

The core drill bit of any one of embodiments 1 to 4, wherein the first region has a first hardness RH1 and the second region has a second hardness RH2 and wherein RH1 is different than RH2.

### Embodiment 9

The core drill bit of embodiment 6, wherein RH1 is greater than RH2.

### Embodiment 10

The core drill bit of any one of embodiments 1 to 4, wherein the first region defines a ring-shaped element.

### Embodiment 11

The core drill bit of any one of embodiments 1 to 4, wherein the first region defines a hollow core cutting element.

### Embodiment 12

The core drill bit of any one of embodiments 10 or 11, wherein the first region has an outer diameter and an inner diameter.

### Embodiment 13

The core drill bit of embodiment 12, wherein the first region has a uniform outer diameter.

### Embodiment 14

The core drill bit of embodiment 12, wherein the first region has a uniform inner diameter.

### Embodiment 15

The core drill bit of any one of embodiments 12 or 13, wherein the outer diameter of the first region is at least at least 5 mm, at least 6.5 mm, or at least 8 mm.

### Embodiment 16

The core drill bit of any one of embodiments 12 or 13, wherein the outer diameter of the first region is not greater than 125 mm, not greater than 120 mm, or not greater than 115 mm.

### Embodiment 17

The core drill bit of any one of embodiments 12 or 13, wherein the inner diameter of the first region is at least 3.2 mm, at least 5 mm, at least 7.5 mm, or at least 10 mm.

### Embodiment 18

The core drill bit of any one of embodiments 12 or 13, wherein the inner diameter of the first region is not greater than 123.2 mm, not greater than 115 mm, not greater than 105 mm, not greater than 95 mm, or not greater than 80 mm.

### Embodiment 19

The core drill bit of any one of embodiments 1 to 4, wherein the second region comprises a seamer element.

### Embodiment 20

The core drill bit of any one of embodiments 1 to 4, wherein the second region comprises a chamfer.

### Embodiment 21

The core drill bit of any one of embodiments 12, 19 and 20, wherein the second region has a maximum outer diameter and wherein the maximum outer diameter of the second region is greater than the outer diameter of the first region.

### Embodiment 22

The core drill bit of embodiment 21, wherein the maximum outer diameter of the second region is at least 7 mm, at least 9 mm, at least 10.5 mm, or at least 12 mm.

### Embodiment 23

The core drill bit of embodiment 21, wherein the maximum outer diameter of the second region is not greater than not greater than 250 mm, not greater than 230 mm, not greater than 210 mm, or not greater than 200 mm.

### Embodiment 24

The core drill bit of any one of embodiments 1 to 4, wherein the first region is bonded to the second region.

### Embodiment 25

The core drill bit of any one of embodiments 1 to 4, wherein the core drill bit further comprises a joint region connecting the first region and the second region.

### Embodiment 26

The core drill bit of embodiment 25, wherein the joint region comprises a mixture of the first bond matrix and the second bond matrix.

### Embodiment 27

The core drill bit of embodiment 26, wherein the joint region comprises an interfacial layer.

### Embodiment 28

The core drill bit of embodiment 27, wherein the interfacial layer comprises a distinct phase from both the first region and the second region.

### Embodiment 29

The core drill bit of embodiment 27, wherein the core drill bit comprises an elemental weight percent difference between the composition of the first bond matrix and the second bond matrix of not greater than about 99%, not greater than 90%, not greater than 85%, not greater than 80%, not greater than 75% or not greater than 70%.

### Embodiment 30

The core drill bit of embodiment 29, wherein the core drill bit comprises an elemental weight percent difference between the compositions of the first bond matrix and the second bond matrix of at least 1%.

### Embodiment 31

The core drill bit of embodiment 29, the core drill bit comprises an elemental weight percent difference between the compositions of the first bond matrix and the interfacial layer of not greater than about 60%.

### Embodiment 32

The core drill bit of embodiment 29, the core drill bit comprises an elemental weight percent difference between the compositions of the first bond matrix and the interfacial layer of at least about 0.2%.

### Embodiment 33

The core drill bit of any one of the previous embodiments, wherein the core drill bit comprises at least one annular cross-section about a longitudinal axis of the drill bit.

### Embodiment 34

The core drill bit of any one of the previous embodiments, wherein the first region comprises an annular cross-section about a longitudinal axis of the drill bit.

### Embodiment 35

The core drill bit of any one of the previous embodiments, wherein the second region comprises an annular cross-section about a longitudinal axis of the drill bit.

### Embodiment 36

The core drill bit of any one of the previous embodiments, wherein the joint region comprises an annular cross-section about a longitudinal axis of the drill bit.

### Embodiment 37

The core drill bit of any one of the previous embodiments, wherein the first bond matrix comprises a first bond material including an elemental metal, a metal alloy, or a combination thereof.

### Embodiment 38

The core drill bit of embodiment 37, wherein the first bond material comprises iron, tungsten, cobalt, nickel, chromium, titanium, silver, or any combination thereof.

### Embodiment 39

The core drill bit of any one of the previous embodiments, wherein the first bond matrix comprises a first infiltrant material.

### Embodiment 40

The core drill bit of any one of the previous embodiments, wherein the first infiltrant material includes an elemental metal, a metal alloy, or any combination thereof.

### Embodiment 41

The core drill bit of embodiment 39 or 40, wherein the first infiltrant material includes an alloy including a transitional metal element.

### Embodiment 42

The core drill bit of any one of embodiments 39 to 41, wherein the first infiltrant material includes copper, tin, zinc, or a combination thereof.

### Embodiment 43

The core drill bit of any one of the previous embodiments, wherein the second bond matrix comprises a second bond material including an elemental metal, an alloy, or a combination thereof.

### Embodiment 44

The core drill bit of any one of the previous embodiments, wherein the second bond material comprises iron, tungsten, cobalt, nickel, chromium, titanium, silver, tin, or a combination thereof.

### Embodiment 45

The core drill bit of any one of the previous embodiments, wherein the second bond matrix comprises a second infiltrant material including a transitional metal element.

### Embodiment 46

The core drill bit of embodiment 45, wherein the second bond matrix comprises at least about 1% Sn for a total weight of the second bond matrix.

### Embodiment 47

The core drill bit of embodiment 8, wherein RH1 is at least about 101 HRB.

### Embodiment 48

The core drill bit of embodiment 8, wherein RH2 is not greater than 101 HRB.

### Embodiment 49

The core drill bit of any one of the previous embodiments, wherein the abrasive particles comprise a superabrasive material.

### Embodiment 50

The core drill bit of embodiment 49, wherein the superabrasive material comprises diamond, cubic boron nitride (cBN), or any combination thereof.

### Embodiment 51

The core drill bit of embodiment 49, wherein the superabrasive material consists of diamond, cubic boron nitride (cBN), or any combination thereof.

### Embodiment 52

The core drill bit of any one of the previous embodiments, wherein the abrasive particles have an average particle size of at least 30 microns and not greater than 150 microns.

### Embodiment 53

The core drill bit of any one of embodiments 1 to 4, wherein the first region comprises an abrasive particle concentration of at least about 1% for a total weigh of the first region, at least about 3%, at least about 4% and at least about 5%.

### Embodiment 54

The core drill bit of any one of embodiments 1 to 4, wherein the first region comprises an abrasive particle concentration of not greater than about 20% for a total weigh of the first region, not greater than about 15%, not greater than about 10% and not greater than about 8%.

### Embodiment 55

The core drill bit of any one of embodiments 1 to 4, wherein the second region comprises an abrasive particle concentration of at least about 1% for a total weigh of the second region, at least about 3%, at least about 4%, or at least about 5%.

### Embodiment 56

The core drill bit of any one of embodiments 1 to 4, wherein the second region comprises an abrasive particle concentration of not greater than about 20% for a total weigh of the second region, not greater than about 15%, not greater than about 10%, not greater than about 8%.

### Embodiment 57

The core drill bit of any one of embodiments 1 to 4, wherein the first region comprises a first bond matrix concentration of at least 90% for a total weight of the first region, at least 92%, at least 95%, or at least 98%.

### Embodiment 58

The core drill bit of any one of embodiments 1 to 4, wherein the first region comprises a first bond matrix concentration of not greater than 99% for a total weight of the first region, such as not greater than 98% or not greater than 97%.

### Embodiment 59

The core drill bit of any one of embodiments 1 to 4, wherein the second region comprises a second bond matrix concentration of at least 90% for a total weight of the second region, at least 92%, at least 93%, or at least 94%.

### Embodiment 60

The core drill bit of any one of embodiments 1 to 4, wherein the second region comprises a second bond matrix concentration of not greater than 99% for a total weight of the second region, such as not greater than 98% or not greater than 97%.

### Embodiment 61

The core drill bit of any one of embodiments 1 to 4, wherein the first region comprises a porosity of at least 0.2 vol % for a total volume of the first region, at least 0.3 vol %, at least 0.4 vol %, at least 0.5 vol %, at least 0.8 vol %, or at least 1 vol %.

### Embodiment 62

The core drill bit of any one of embodiments 1 to 4, wherein the first region comprises a porosity of not greater than 5 vol % for a total volume of the first region, such as not greater than 4 vol %, or not greater than 3 vol %.

### Embodiment 63

The core drill bit of any one of embodiments 1 to 4, wherein the second region comprises a porosity of at least about 0.1 vol % for a total volume of the second region, at least 0.5 vol %, at least 1 vol %, at least 2 vol %, at least 3 vol %, or at least 4 vol %.

### Embodiment 64

The core drill bit of any one of embodiments 1 to 4, wherein the second region comprises a porosity of not greater than 10 vol % for a total volume of the second region, such as not greater than 9 vol %, or not greater than 8 vol %.

### Embodiment 65

The core drill bit of any one of embodiments 1 to 5, further comprising a seamer angle of at least 45 degrees, such as at least 46 degrees, at least 47 degrees or at least 48 degrees.

### Embodiment 66

The core drill bit of any one of embodiments 1 to 5, further comprising a seamer angle of not greater than 55 degrees, such as not greater than 53 degrees, not greater than 52 degrees, or not greater than 51 degrees.

### Embodiment 67

The core drill bit of any one of the preceding embodiments, wherein the abrasive tip comprises a beveled edge.

### Embodiment 68

The core drill bit of any one of embodiments 1 to 4, wherein the first region comprises a filler including silicon carbide, tungsten carbide, Al₂O₃, or any combination thereof.

### Embodiment 69

The core drill bit of any one of embodiments 1 to 4, wherein the second region comprises a filler including silicon carbide, tungsten carbide, Al₂O₃, or any combination thereof.

### Embodiment 70

The core drill bit of any one of embodiments 1 to 2, wherein the second average particle size is different than the first average particle size.

### Embodiment 71

The core drill bit of embodiment 70, wherein the second average particle size is at least 5% less than the first average particle size.

### Embodiment 72

The core drill bit of any one of embodiments 1 to 2, wherein the second porosity is different from the first porosity.

### Embodiment 73

The core drill bit of any one of embodiments 1 to 2, wherein the second region comprises a different pore size distribution than the first region.

### Embodiment 74

A method, comprising:
forming at least one of a first precursor body or second precursor body of an abrasive article by an additive manufacturing process;
applying heat to at least a portion of the first precursor body or second precursor body to form an abrasive article comprising:
an abrasive tip including a first region including a first bond material and abrasive particles and a second region including a second bond material and abrasive particles, wherein the first bond material and second bond material are different from each other.

### Embodiment 75

The method of embodiment 74, wherein the first precursor body is formed in a layer-by-layer manner, wherein a binder material is applied to at least some of the first layers.

### Embodiment 76

The method of embodiment 74 or 75, wherein the second precursor body is formed in a layer-by-layer manner, wherein a binder material is applied to at least some of the second layers.

### Embodiment 77

The method of any one of embodiments 74 to 76, wherein a first layer of the second precursor body is formed on top of a last layer of the first precursor body.

### Embodiment 78

The method of any one of embodiments 74 to 77, wherein the second precursor body is attached to the first precursor body.

### Embodiment 79

The method of any one of embodiments 74 to 78, wherein the second precursor body is formed separately from the first precursor body.

### Embodiment 80

The method of any one of embodiments 74 to 79, wherein each of the first and second precursor bodies comprises a porosity of at least 40 vol % for a total volume of the respective precursor body.

### Embodiment 81

The method of any one of embodiments 74 to 80, wherein applying the heat comprises applying an infiltrant material to at least a portion of one of the first and second precursor bodies.

### Embodiment 82

The method of any one of embodiments 74 to 81, wherein applying the heat comprises applying an infiltrant material to both the first and second precursor bodies and joining the first and second precursor bodies.

### Embodiment 83

The method of any one of embodiments 74 to 82, further comprising forming an interfacial layer between the first and second precursor bodies.

### Embodiment 84

The method of any one of embodiments 81 to 83, wherein the infiltrant material comprises a molten metal element, a molten alloy, or a combination thereof.

### Embodiment 85

The method of embodiment 83 or 84, wherein the first region and the second region of the abrasive tip are bonded by the interfacial layer.

### Embodiment 86

The method of embodiment 85, wherein the interfacial layer comprises the infiltrant material.

### Embodiment 87

The method of embodiment 85 or 86, wherein the interfacial layer consists essentially of the infiltrant material.

### EXAMPLES

### Example 1

Glass core drill bit Sample S1 is formed. The length of the drill including an abrasive tip and drill body and the shaft is 75 mm and 55 mm, respectively. The abrasive tip has a thickness of 2 mm, an outer diameter of 11.5 mm, and inner diameter of 9.7 mm. The drill body has an outer diameter of 15.5 mm, and inner diameter of 9.7 mm. The precursor abrasive tip and drill body are separately formed using a binder jetting 3D printer from ExOne (e.g., ExOne R2) following the manufacturer's instructions. The precursor abrasive tip is formed including a bond material including Co and Fe and diamond abrasive particles, and then infiltrated with Cu. The precursor drill body is printed including a bond material including Co and diamond abrasive particles and then infiltrated with Sn. The finally formed abrasive tip and drill body are joined and connected to the shaft by brazing.

The concentrations of the components in the bond matrix of the finally formed abrasive tip and drill body are included in Table 1. Each of the abrasive tip and the drill body includes 6% of diamond abrasive particles having the same average particle size (D₅₀). The concentration of each component is relative to the respective weight of the abrasive tip and the drill body.

TABLE 1

| | Abrasive Tip (%) | Drill body |
|---|---|---|
| Sample S1 | Co/Fe/Cu: 27/66/7 | Co/Sn: 97/3 |

### Example 2

Glass core drill bit Sample S2 is formed. S2 has the same dimensions as S1. A single precursor body including the abrasive tip and drill body is formed using a binder jetting 3D printer from ExOne (e.g., ExOne R2) following the manufacturer's instructions. The precursor body is infiltrated and joined to the shaft. The abrasive tip and drill body include the same bond matrix composition and concentration of diamond abrasive particles. The average abrasive particle size (D₅₀) of the drill body is 5% less than the average abrasive particle size (D₅₀) of the abrasive tip.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive. Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A core drill bit comprising an abrasive tip and a drill body, wherein the abrasive tip comprises:
a first region comprising abrasive particles contained within a first bond matrix, wherein the first region comprises a Fast Fourier Transform value greater than 1; and
a second region comprising abrasive particles contained within a second bond matrix;
wherein the first region comprises at least one first abrasive characteristic selected from the group of a first bond matrix composition, a first bond matrix concentration, a first bond material composition, a first bond material content (vol %), a first infiltrant composition, a first infiltrant content (vol %), a first average abrasive particle size, a first abrasive particle concentration, a first type of pores, a first average pore size, a first pore size distribution, and a first porosity, a first filler composition, and a first filler concentration;
wherein the second region comprises at least one second abrasive characteristic selected from the group of a second bond matrix composition, a second bond matrix concentration, a second bond material composition, a second bond material content (vol %), a second infiltrant composition, a second infiltrant content (vol %), a second average abrasive particle size, a second abrasive particle concentration, a second type of pores, a second average pore size, a second pore size distribution, a second porosity, a second filler composition, and a second filler concentration; and
wherein at least one first abrasive characteristic is different than at least one corresponding second abrasive characteristic.

2. The core drill bit of claim 1, wherein the first region is bonded to the second region.

3. The core drill bit of claim 1, wherein the first bond matrix composition is different from the second bond matrix composition.

4. The core drill bit of claim 1, wherein the first region defines a hollow core cutting element and include an outer diameter and an inner diameter.

5. The core drill bit of claim 1, wherein the second region comprises a maximum outer diameter, and wherein the maximum outer diameter of the second region is greater than the outer diameter of the first region.

6. The core drill bit of claim 1, wherein the first bond matrix comprises a first bond material and a first infiltrant material, wherein the first bond material comprises iron, tungsten, cobalt, nickel, chromium, titanium, silver, vanadium, molybdenum, or any combination thereof.

7. The core drill bit of claim 6, wherein the first infiltrant material comprises copper, tin, zinc, or a combination thereof.

8. The core drill bit of claim 6, wherein the second bond matrix comprises a second bond material and a second infiltrant material, wherein the second bond material comprises iron, tungsten, cobalt, nickel, chromium, titanium, silver, tin, vanadium, molybdenum, or a combination thereof.

9. The core drill bit of claim 8, wherein the second bond matrix comprises at least 1% Sn for a total weight of the second bond matrix.

10. The core drill bit of claim 8, wherein the first infiltrant material is different than the second infiltrant material.

11. The core drill bit of claim 1, wherein the core drill bit further comprises an interfacial layer connecting the first region and the second region, wherein the interfacial layer comprises a mixture of the first bond matrix and the second bond matrix.

12. The core drill bit of claim 1, wherein each of the first region and the second region comprises a Fast Fourier Transform value greater than 1.

13. A core drill bit comprising an abrasive tip and a drill body, wherein the abrasive tip comprises:
a longitudinal axis running a length of the core drill bit;
a first region comprising abrasive particles contained within a first bond matrix, wherein the first region comprises an annular cross-section about the longitudinal axis of the core drill bit; and
a second region comprising abrasive particles contained within a second bond matrix, wherein the second region comprises an annular cross-section about the longitudinal axis of the core drill bit,
wherein the first region comprises at least one first abrasive characteristic selected from the group of a first bond matrix composition, a first bond matrix concentration, a first bond material composition, a first bond material content (vol %), a first infiltrant composition, a first infiltrant content (vol %), a first average abrasive particle size, a first abrasive particle concentration, a first type of pores, a first average pore size, a first pore size distribution, and a first porosity, a first filler composition, and a first filler concentration;
wherein the second region comprises at least one second abrasive characteristic selected from the group of a second bond matrix composition, a second bond matrix concentration, a second bond material composition, a second bond material content (vol %), a second infiltrant composition, a second infiltrant content (vol %), a second average abrasive particle size, a second abrasive particle concentration, a second type of pores, a second average pore size, a second pore size distribution, a second porosity, a second filler composition, and a second filler concentration;
wherein at least one first abrasive characteristic is different than at least one corresponding second abrasive characteristic; and
wherein at least one of the first region and the second region has a Fast Fourier Transform value greater than 1.

14. The core drill bit of claim 13, wherein at least one of the first and second regions comprises an annular cross-section about the longitudinal axis of the drill bit.

15. The core drill bit of claim 13, wherein the first region defines a hollow core cutting element, and wherein the second region comprises a chamfer.

16. The core drill bit of claim 13, further comprising an interfacial layer connecting the first and second regions, wherein the interfacial layer comprises a distinct phase from both the first region and the second region.

17. The core drill bit of claim 13, wherein the core drill bit comprises an elemental weight percent difference between the first bond matrix composition and the second bond matrix composition, wherein the elemental weight percent difference is at least 1% and not greater than 60%.

18. The core drill bit of claim 13, wherein the first average particle size is at least 25 microns and not greater than 400 microns.

19. The core drill bit of claim 18, wherein the first average abrasive particle size is greater than the second average abrasive particle size.

20. The core drill bit of claim 13, wherein the first porosity is less than the second porosity.
